(19) United States
(12) Patent Application Publication
(10) Pub. No.: US 2026/0142390 A1
(43) Pub. Date: May 21, 2026

(54) BUSBAR CLIP ASSEMBLY, CONNECTOR ASSEMBLY, AND BUSBAR CLIP

(71) Applicant: Bellwether Electronic Corp., Taoyuan City (TW)

(72) Inventors: Robert Hla THEIN, Taoyuan City (TW); Hsin-Ching HSU, Taoyuan City (TW); Jimmy Enrique ACERA, Taoyuan City (TW)

(21) Appl. No.: 19/392,051

(22) Filed: Nov. 17, 2025

Related U.S. Application Data
(60) Provisional application No. 63/723,140, filed on Nov. 21, 2024.

(51) Int. Cl. H01R 9/22; H01R 4/48

(52) U.S. Cl. CPC H01R 9/226; H01R 4/485; H01R 9/223

(57) ABSTRACT

A busbar clip assembly includes: a plurality of busbar clips, each configured to clip a plurality of busbars respectively, wherein each busbar clip includes a main frame and a conductive terminal structure installed in the main frame, and wherein the conductive terminal structure of one busbar clip is directly connected to the conductive terminal structure of the other busbar clip or connected through a connecting element.

### PRIORITY CLAIM AND CROSS-REFERENCE

This application claims priority to U.S. Provisional Application Serial Number 63/723,140 filed November 21, 2024, the disclosure of which is incorporated herein by reference in their entirety.

### BACKGROUND

In modern power distribution systems, busbars are metal conductors used to conduct large amounts of current and are widely used in power systems, industrial equipment, data centers, and new energy vehicles. To ensure a stable connection between the busbar and other electrical components (such as distribution boards and terminal blocks), busbar clips have become an indispensable connection solution.

Conventional busbar clips are susceptible to thermal expansion during prolonged high-current operation, leading to a decrease in contact pressure, which can cause problems such as poor contact and localized overheating. If the busbar is not properly connected to other electrical components, this can potentially lead to poor power transmission. Therefore, a high-performance busbar clip assembly, connector assembly, and busbar clip are needed to address these potential issues.

### SUMMARY

The disclosure provides a busbar clip assembly, comprising: a plurality of busbar clips, each configured to clip a plurality of busbars respectively, wherein each busbar clip comprises a main frame and a conductive terminal structure installed in the main frame, and wherein, the conductive terminal structure of one busbar clip is directly connected to the conductive terminal structure of the other busbar clip or connected through a connecting element.

In some embodiments, wherein a spring structure is disposed on the conductive terminal structure, and the spring structure contacts one of the busbars.

In some embodiments, wherein: the conductive terminal structure of one of the busbar clips comprises a first conductive terminal and a second conductive terminal, and the conductive terminal structure of the other of the busbar clips comprises a first conductive terminal and a second conductive terminal, wherein the first conductive terminal of the conductive terminal structure of the one of the busbar clips and the first conductive terminal of the conductive terminal structure of the other of the busbar clips are integrally formed, and the second conductive terminal of the conductive terminal structure of the one of the busbar clips and the second conductive terminal of the conductive terminal structure of the other of the busbar clips are integrally formed.

In some embodiments, wherein the connecting element comprises a housing and a conductive plate disposed in the housing, wherein the busbar clips are fixed on the conductive plate.

In some embodiments, wherein the connecting element comprises a conductive plate with an L-shaped profile, and the busbar clips are fixed on the conductive plate.

In some embodiments, wherein the connecting element comprises a conductive plate with a plurality of conductive sheets, and the busbar clips are fixed on the conductive plate.

In some embodiments, wherein each of the busbar clips can be fixed on the connecting element in two different directions.

The disclosure provides a connector assembly, comprises: a busbar clip assembly comprising: a plurality of busbar clips, each configured to clip a plurality of busbars, wherein each of the busbar clips comprises a main frame and a conductive terminal structure mounted within the main frame; and a connector, electrically connected to the conductive terminal structure of one of the busbar clips and the conductive terminal structure of another of the busbar clips, and comprising: a housing; a plurality of conductive strips, comprising: a first conductive strip disposed within the housing and configured to receive a first voltage, wherein one of the busbar clips is electrically connected to the first conductive strip; and a second conductive strip disposed within the housing and configured to receive a second voltage, wherein the other of the busbar clips is electrically connected to the second conductive strip, and wherein the second voltage is the same as or different from the first voltage.

In some embodiments, wherein one of the conductive strips comprises: an outer conductive strip; an inner conductive strip adjacent to but not in contact with the outer conductive strip; and an intermediate conductive strip between the outer conductive strip and the inner conductive strip.

In some embodiments, wherein the conductive strips further comprises: a positioning piece on an outer surface of the outer conductive strip, wherein when the conductive strips are installed in the housing of the connector, the positioning piece abuts against a stopper of the housing.

In some embodiments, wherein a guide groove is defined between the outer conductive strip and the positioning piece, wherein when the one of the conductive strips is installed in the housing, a guide post of the housing is embedded in the guide groove.

In some embodiments, wherein one of the conductive strips comprises: an outer conductive strip; an inner conductive strip adjacent to but not contacting the outer conductive strip; and an extension strip, comprising: a first portion positioned between the outer conductive strip and the inner conductive strip; and a second portion connected to the first portion, wherein the second portion has a thickness greater than that of the first portion, and wherein one of the busbar clips is mounted on the second portion.

In some embodiments, wherein the second portion has a curved profile.

In some embodiments, wherein one of the conductive strips comprises: a first extension piece contacting the one of the conductive strips; a second extension piece contacting the first extension piece; and a third extension piece, comprising: a first portion contacting the second extension piece; and a second portion connected to an end of the first portion proximal to a slot of the connector and aligned approximately 90 degrees to the first portion, wherein one of the busbar clips is mounted on the second portion.

The disclosure provides a busbar clip, comprises: a plurality of conductive terminal structures, comprising: a base; a conductive platform extending from the base; a spring structure disposed on the conductive platform; and a main frame enclosing the conductive terminal structures, wherein the main frame comprises a separable first frame and a separable second frame.

In some embodiments, wherein the base of one of the conductive terminal structures has a positioning column, and the base of the other one has a positioning hole, and the positioning column is inserted into the positioning hole.

In some embodiments, wherein the base of the conductive terminal structures comprises a guide groove coupled with a guide column of the main frame.

The disclosure provides a busbar clip, comprises: a plurality of conductive terminal structures, comprising: a base; a conductive platform extending from the base; a spring structure disposed on the conductive platform; and a main frame enclosing the conductive terminal structures, wherein the main frame is a one-piece structure, and the conductive terminal structures are separated by a wall of the main frame.

The disclosure provides a busbar clip, comprises: a plurality of conductive terminal structures, comprising: a base; a first conductive platform extending from the base in a first direction; a second conductive platform extending from the base in a second direction opposite to the first direction; and a plurality of spring structures disposed on the first conductive platform and the second conductive platform; a first main frame enclosing the first conductive platform of each of the conductive terminal structures; and a second main frame enclosing the second conductive platform of each of the conductive terminal structures.

In some embodiments, wherein each of the first main frame and the second main frame comprises a separable first frame and a separable second frame.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIGS. 1A to 1F are perspective views of a busbar clip according to some embodiments of the present disclosure.

FIG. 2 is a perspective view of a busbar clip according to some embodiments of the present disclosure.

FIG. 3A is a perspective view of a busbar clip assembly according to some embodiments of the present disclosure.

FIG. 3B is an exploded view of a busbar clip assembly according to some embodiments of the present disclosure.

FIG. 4A is a perspective view of a busbar clip assembly according to some embodiments of the present disclosure.

FIG. 4B is an exploded view of a busbar clip assembly according to some embodiments of the present disclosure.

FIG. 5A is a perspective view of a busbar clip assembly according to some embodiments of the present disclosure.

FIG. 5B is an exploded view of a busbar clip assembly according to some embodiments of the present disclosure.

FIG. 6A is a perspective view of a connector assembly according to some embodiments of the present disclosure.

FIG. 6B is a perspective view of a connector assembly according to some embodiments of the present disclosure.

FIG. 6C is a schematic diagram illustrating the connection relationship of the connector assembly according to some embodiments of the present disclosure.

FIG. 7A is a perspective view of the connector assembly according to some embodiments of the present disclosure.

FIG. 7B is a schematic diagram illustrating the connection relationship of a connector assembly according to some embodiments of the present disclosure.

FIG. 8 is a perspective view of a connector assembly according to some embodiments of the present disclosure.

FIG. 9 is a perspective view of a connector assembly according to some embodiments of the present disclosure.

### DETAILED DESCRIPTION

Various example embodiments will be described more fully hereinafter with reference to the accompanying drawings, in which some example embodiments are shown. The present disclosure may, however, be embodied in many different forms and should not be construed as limited to the example embodiments set forth herein. Rather, these example embodiments are provided so that this disclosure will be thorough and complete, and will fully convey the scope of the present disclosure to those skilled in the art. It is noted that, in accordance with the standard practice in the industry, various features are not drawn to scale. In fact, the dimensions of the various features may be arbitrarily increased or reduced for clarity of discussion.

The following disclosure provides many different embodiments or examples for implementing different features of the provided subject matter. Specific examples of components and arrangements are described below to simplify the present disclosure. These are, of course, merely examples, and are not intended to be limiting. For example, in the following description, the formation of a first feature above or on a second feature may include embodiments in which the first and second features are formed in direct contact, and may also include embodiments in which additional features may be formed between the first and second features so that the first and second features are not in direct contact. Furthermore, in various examples, the present disclosure may repeat reference numerals and/or letters. This repetition is for the purpose of simplicity and clarity and does not in itself dictate a relationship between the various embodiments and/or configurations discussed.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Hereinafter, example embodiments will be explained in detail with reference to the accompanying drawings.

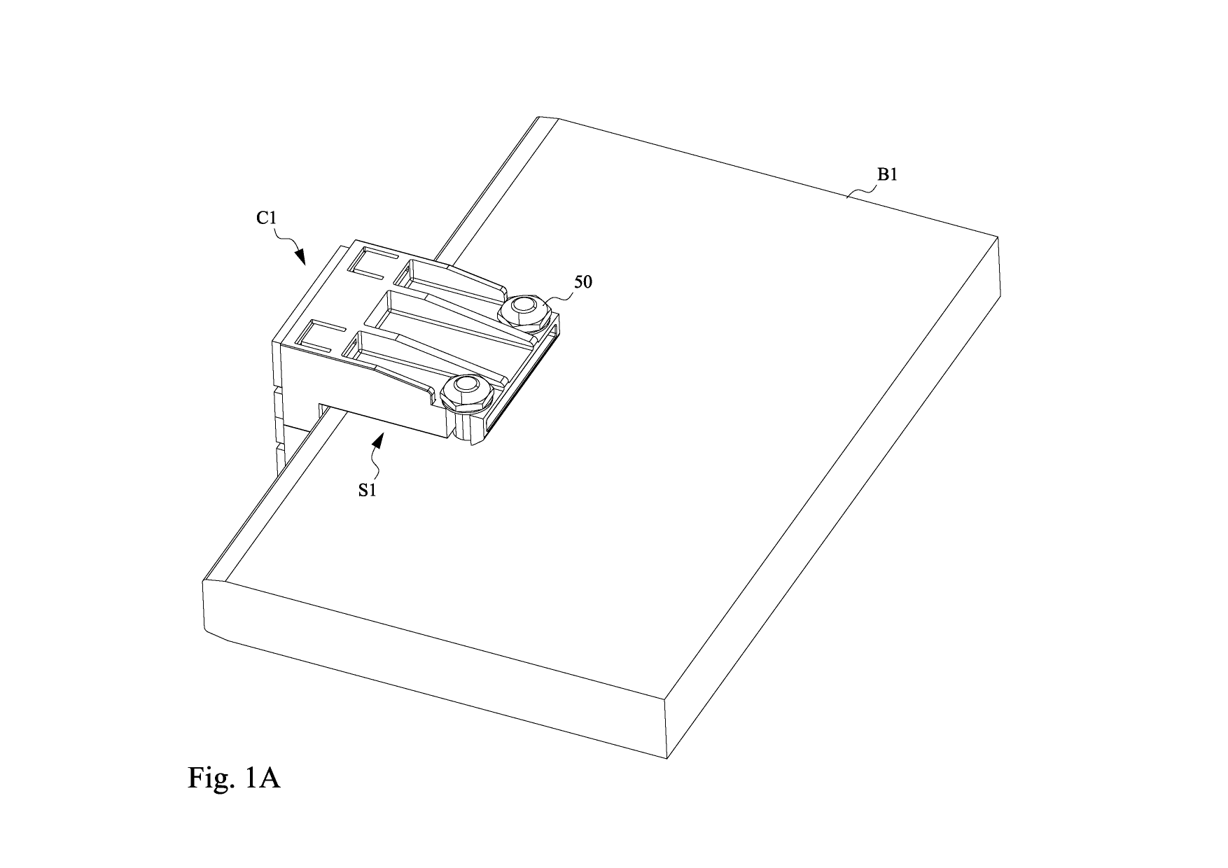

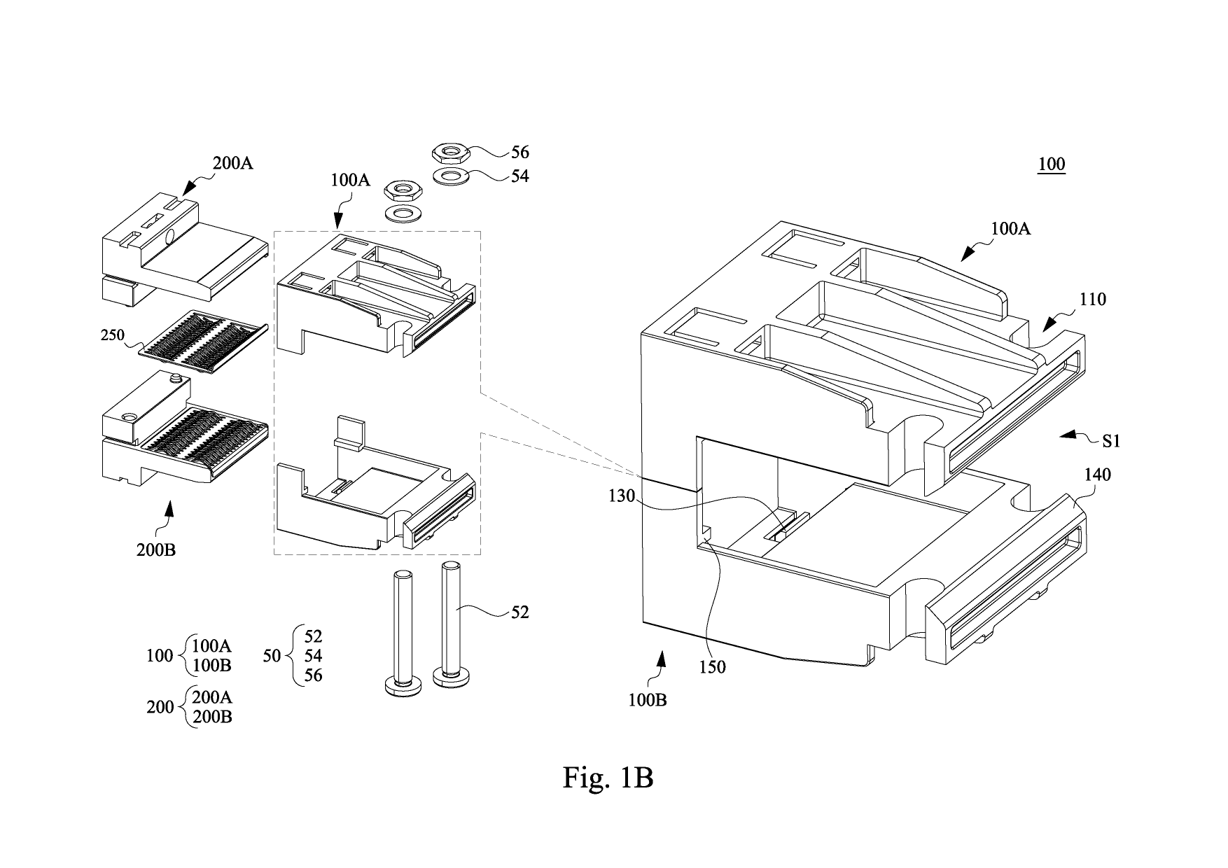

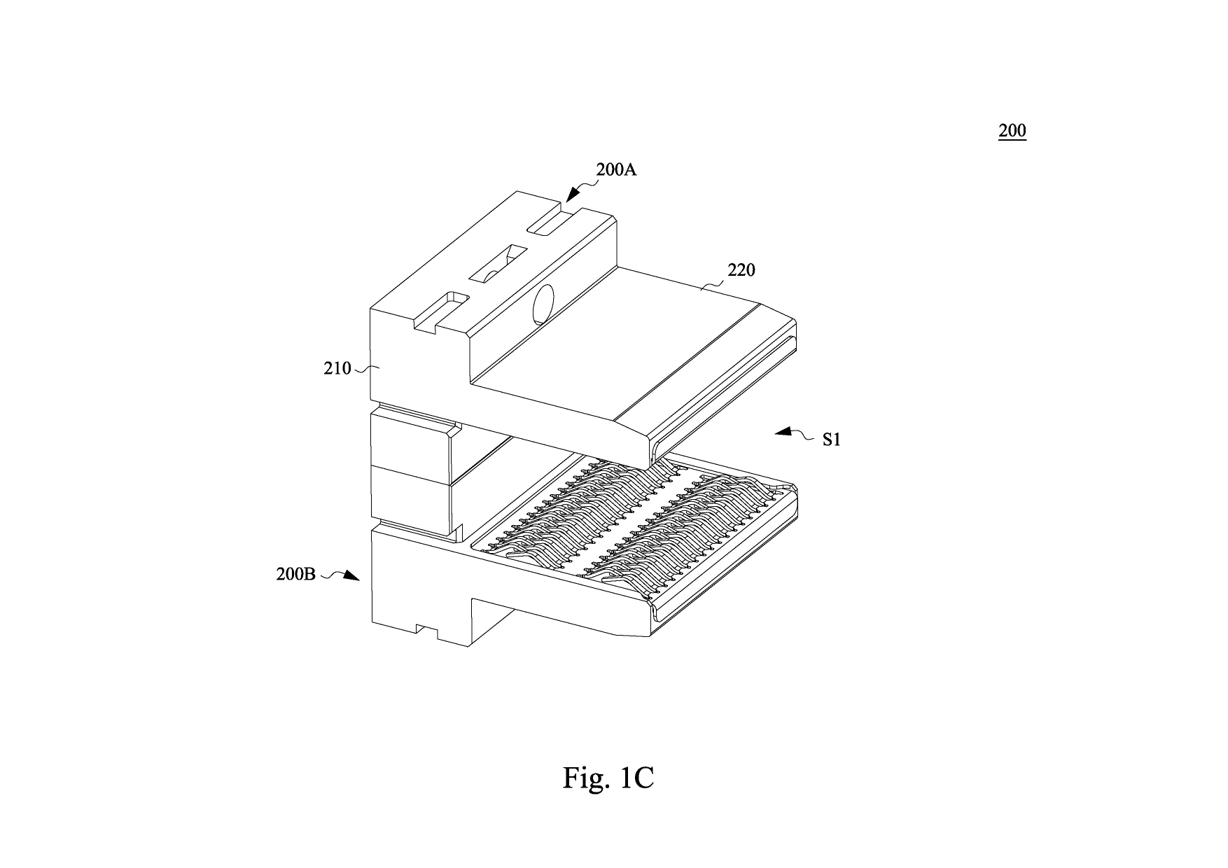

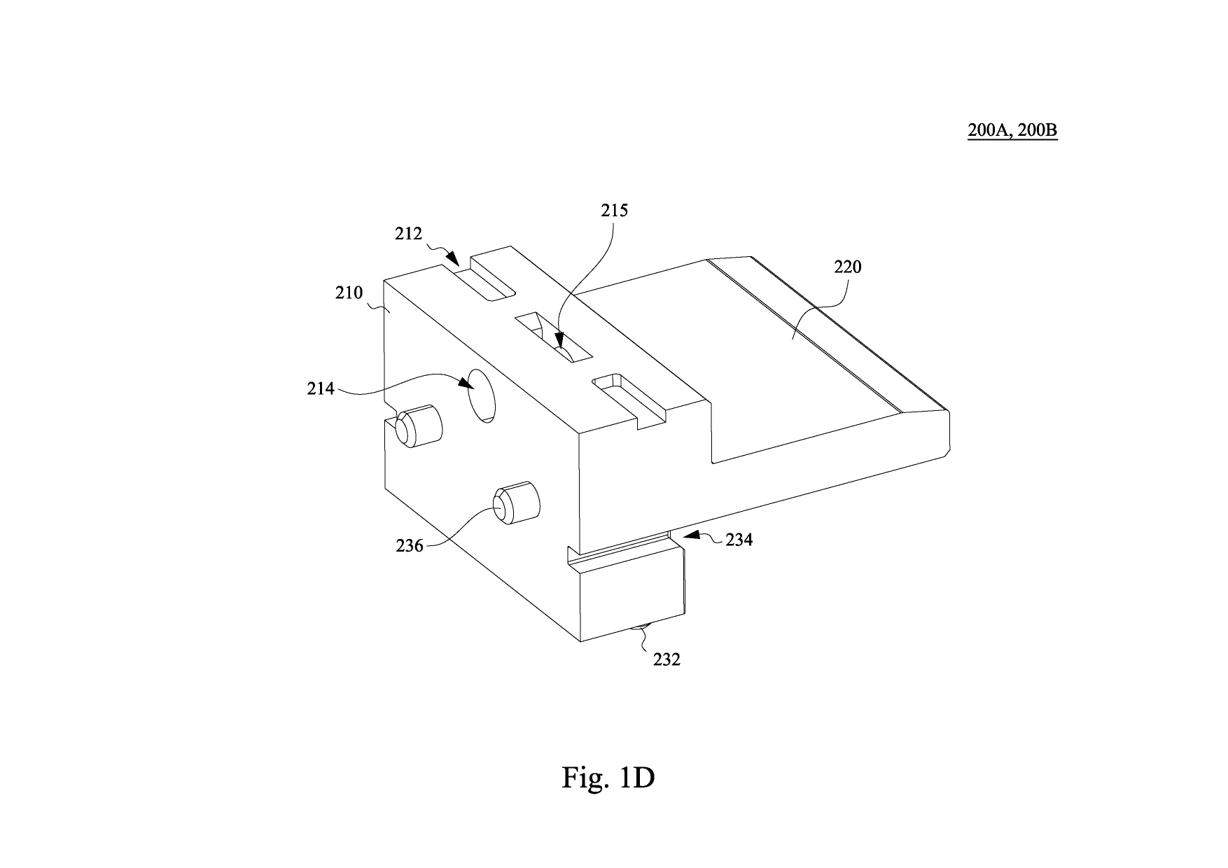

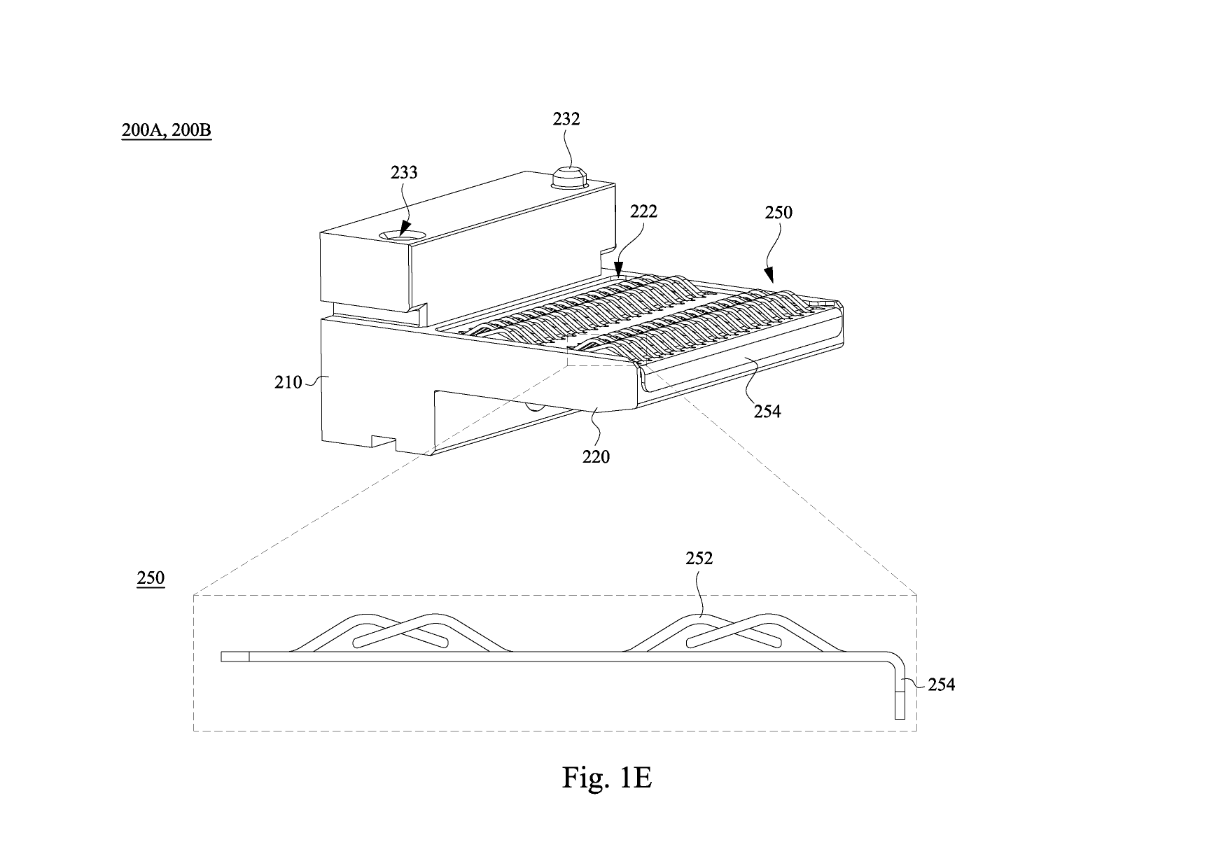

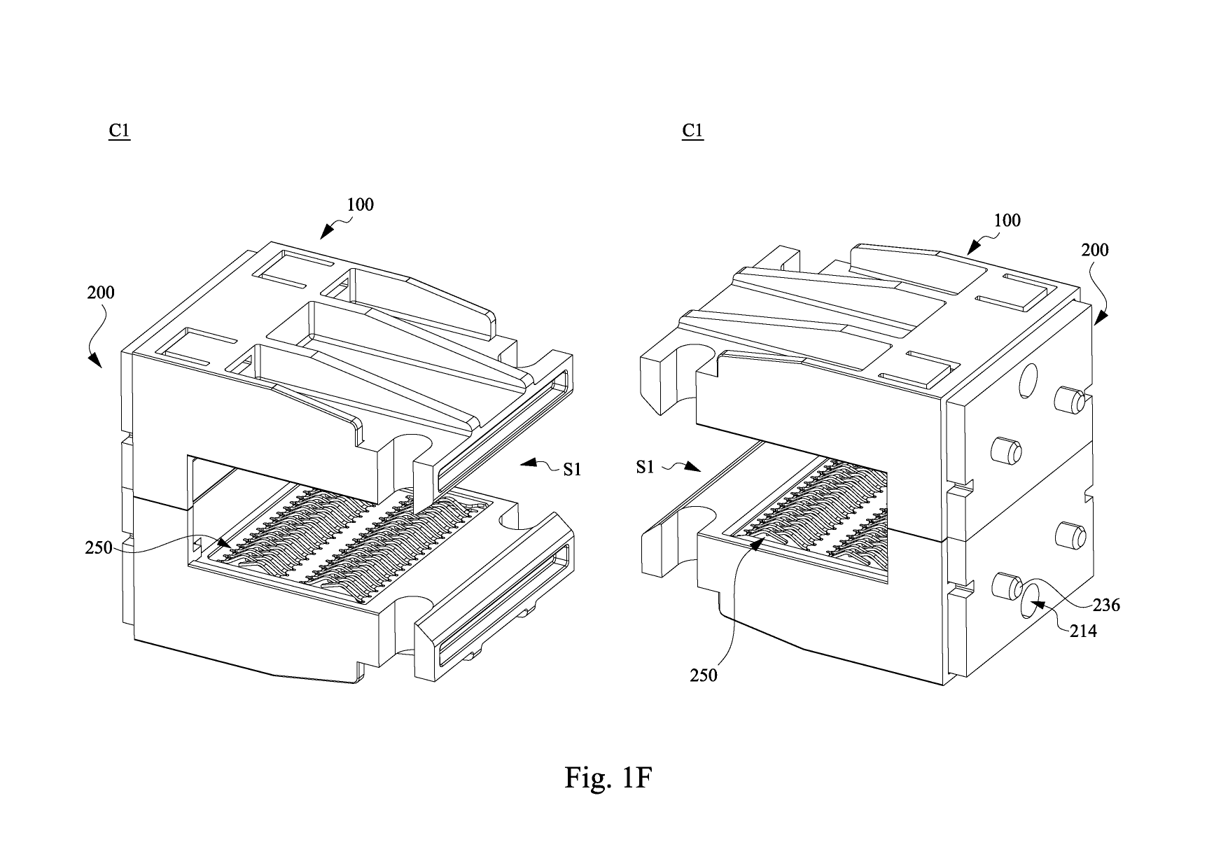

FIGS. 1A to 1F discuss the detailed structure of a busbar clip C1. Please refer to FIG. 1A. The busbar clip C1 is configured to clip the busbar B1 and electrically connect the busbar B1 to other electrical components (such as a distribution board, terminal blocks, etc.), while ensuring a stable and reliable power connection. The busbar clip C1 has a slot S1, which is defined by the internal structure of the busbar clip C1 body and is used to clip and fix the busbar B1. Therefore, a portion of the busbar B1 is located between the busbar clip C1. In some embodiments, the busbar B1 can be a metal plate or metal strip with conductive properties, and the material includes a conductive material, such as copper.

Specifically, busbar clip C1 and busbar B1 each includes a plurality of fixing holes for insertion and locking of fixing elements 50. Specifically, busbar B1 can be moved to the slot S1 of busbar clip C1, and fixing elements 50 can be inserted through the fixing holes of busbar clip C1 and busbar B1, respectively, to secure busbar clip C1 and busbar B1 together.

Please refer to FIG. 1B. In some embodiments, the fixing element 50 may include a screw 52, a washer 54, and a nut 56 that pass through the screw 52. The washer 54 and nut 56 have a ring-shaped structure. First, the screw 52 is passed through the fixing holes of the busbar clip C1 and the busbar B1, leaving a portion of the screw 52 protruding from the busbar clip C1. Then, the washer 54 and nut 56 are sequentially inserted into the protruding portion of the screw 52. The nut 56 is then screwed into the threads of the screw 52 to secure it to the screw 52.

The fixing element 50 is configured to enhance the normal force between the busbar clip C1 and the busbar B1, i.e., the force perpendicular to the contact surface between the busbar clip C1 and the busbar B1. In some embodiments, the thickness of the busbar B1 is not restricted, and the length of the busbar clip C1 and the fixing element 50 can be adjusted to match the desired thickness of the busbar B1.

Please refer to FIG. 1B. In some embodiments, the busbar clip C1 includes a main frame 100 and a conductive terminal structure 200.

The main frame 100 is configured to provide basic support. The main frame 100 is generally a square box-shaped structure and is made of an insulating material. In some embodiments, the main frame 100 includes a separate first frame 100A and a second frame 100B, which can be combined to form the main frame 100 and have substantially the same configuration. The first frame 100A and the second frame 100B are separate structures. The first frame 100A and the second frame 100B each includes a plurality of fixing holes 110 for the fixing elements 50 to pass through. In some embodiments, the fixing holes 110 are open openings. For example, the fixing holes 110 are recessed from the side ends of the first frame 100A and the second frame 100B to form a U-shaped, square or other shaped recess. In other embodiments, the fixing holes 110 can be closed openings.

A plurality of fixing structures 130 are provided on the inner bottom surfaces of the first frame 100A and the second frame 100B, located on the left and right sides. In some embodiments, the fixing structures 130 may be outwardly protruding snap-fit structures that engage with corresponding fixing elements (such as the fixing grooves 212 described below) of the conductive terminal structure 200 to achieve secure installation and removal.

The merged main frame 100 defines a slot S1 for the busbar B1 to be inserted.

The first frame 100A and the second frame 100B of the main frame 100 each have a guide surface 140 at the slot S1. Specifically, the guide surface 140 is disposed at the ends of the first frame 100A and the second frame 100B. In some embodiments, the guide surface 140 has a chamfered and beveled design facing the insertion direction of the busbar B1 to guide the insertion of the busbar B1 and reduce scratches or jamming during installation. Specifically, in a cross-sectional view, the guide surface 140 has an opening that gradually widens toward the insertion direction of the busbar B1.

The first frame 100A and the second frame 100B of the main frame 100 are further provided with guide posts 150 on the inner side surfaces. The guide posts 150 facilitate installation of the conductive terminal structure 200 into the main frame 100. In some embodiments, the guide posts 150 are protruded rectangular pillar structures.

Please refer to FIG. 1B, FIG. 1C, FIGS. 1D and 1E. The detailed structure of the conductive terminal structure 200 will be discussed below.

The conductive terminal structure 200 has conductive properties. In some embodiments, the conductive terminal structure 200 includes a first conductive terminal structure 200A and a second conductive terminal structure 200B, which can be combined to form the conductive terminal structure 200 and have substantially the same configuration.

The first conductive terminal structure 200A and the second conductive terminal structure 200B each have a base 210 and a conductive platform 220 extending outward from the base 210.

A slot S1 is defined between the conductive platforms 220 of the combined conductive terminal structure 200 for the busbar B1 to be inserted into.

Please refer to FIG. 1D. For ease of viewing, FIG. 1D shows only one of the first conductive terminal structure 200A and the second conductive terminal structure 200B. The first conductive terminal structure 200A will be used for the following description. In some embodiments, the upper surface of the base 210 of the first conductive terminal structure 200A has a plurality of fixing grooves 212 located on the left and right sides. In some embodiments, the fixing grooves 212 can be inwardly recessed slots that can engage with the corresponding fixing structures 130 of the first frame 100A to achieve stable installation and removal.

In some embodiments, a fixing hole 214 is formed on a side surface of the base 210 of the first conductive terminal structure 200A and extends through the base 210. In some embodiments, the fixing hole 214 may be a cylindrical hole. In some embodiments, a screw may be inserted through the fixing hole 214 to secure the conductive terminal structure 200 to other components. In some embodiments, the top surface of the base 210 further includes a fixing structure 215 that is connected to the fixing hole 214.

The conductive platform 220 extends from the base 210. In some embodiments, the end of the conductive platform 220 has a trapezoidal profile. Specifically, the thickness of the terminal end of the conductive platform 220 has a gradually decreasing profile, which facilitates the conformity with the main frame 100.

The base 210 has a positioning element 232 and a positioning hole 233 on a side opposite to the fixing groove 212 (as shown in FIG. 1E). In some embodiments, the positioning element 232 may be a protruding structure. Specifically, when the first conductive terminal structure 200A and the second conductive terminal structure 200B are assembled, the positioning element 232 of the first conductive terminal structure 200A can be inserted into the positioning hole 233 of the second conductive terminal structure 200B, and the positioning element 232 of the second conductive terminal structure 200B can be inserted into the positioning hole 233 of the first conductive terminal structure 200A.

The base 210 further includes a guide groove 234 configured to engage the conductive terminal structure 200 with the main frame 100. In some embodiments, the guide groove 234 may be a long, concave structure. When the conductive terminal structure 200 is mounted on the main frame 100, the guide post 150 of the main frame 100 can be slid into and coupled to the guide groove 234 of the conductive terminal structure 200. This configuration not only provides a guiding effect but also helps secure the conductive terminal structure 200 to the main frame 100.

The base 210 further includes a plurality of positioning posts 236 on a side opposite the conductive platform 220, configured to engage the conductive terminal structure 200 with other electronic devices. In some embodiments, the positioning posts 236 may be cylindrical, square, or other shaped protruding structures.

Please refer to FIG. 1E. The first conductive terminal structure 200A and the second conductive terminal structure 200B each includes a spring structure 250 disposed on the corresponding conductive platform 220. The spring structures 250 of the first conductive terminal structure 200A and the second conductive terminal structure 200B are disposed opposite to each other and together form a resilient receptacle with a press fit.

The spring structure 250 includes a multi-point contact surface, which includes several raised contact nodes. This allows the busbar B1 to contact simultaneously at multiple points upon insertion, reducing contact resistance and effectively distributing the current path. In some embodiments, the spring structure 250 may include elastic clipping arms (e.g., planar crown springs) that face inward to form an elastic clipping area facing the insertion direction of the busbar B1. This design applies a predetermined contact pressure to the busbar B1 to ensure electrical connectivity.

As shown in FIG. 1E, at least one inner surface of the conductive platform 220 includes a guide rail 222 configured to guide the sliding and engagement of the spring structure 250. In some embodiments, the guide rail 222 is a recessed structure. For example, the spring structure 250 can be slid along the guide rail 222 of the corresponding conductive platform 220 to secure the spring structure 250 to the conductive platform 220.

FIG. 1E also includes a cross-sectional view of a spring structure according to some embodiments. The spring structure 250 is disposed on the surface of the conductive platform 220 facing the slot S1. In some embodiments, the spring structure 250 includes a plurality of contact terminals 252, one of which is a two-intersecting V-shaped structure. This helps increase the electrical contact area with external terminals (such as the busbar B1).

In some embodiments, the spring structure 250 has a positioning element 254 located at the end of the spring structure 250. After the spring structure 250 is inserted into the conductive platform 220, the positioning element 254 can be pressed against a surface of the conductive platform 220.

FIG. 1F is a perspective view of a busbar clip according to some embodiments, showing the busbar clip C1 when the main frame 100 and the conductive terminal structure 200 are combined.

First, the first conductive terminal structure 200A and the second conductive terminal structure 200B can be assembled together. As mentioned above, the first conductive terminal structure 200A and the second conductive terminal structure 200B can be engaged and fixed to each other through the positioning element 232 and the positioning hole 233 (as shown in FIG. 1E) to form the conductive terminal structure 200.

Next, the conductive terminal structure 200 is installed in the main frame 100. Specifically, the guide grooves 234 of the conductive terminal structure 200 can be slid along the guide posts 150 of the main frame 100. Next, the fixing grooves 212 of the conductive terminal structure 200 can be engaged and fixed with the fixing structure 130 of the main frame 100 to form the busbar clip C1.

Busbar B1 can then be inserted into busbar clip C1 along slot S1. The pressing force generated by spring structure 250 enables contact terminals 252 (as shown in FIG. 1E) of spring structure 250 to contact and compress busbar B1, thereby maintaining the positive force exerted by spring structure 250 on busbar B1 within a predetermined range. This appropriately reduces the contact impedance between busbar B1 and spring structure 250 while preventing excessive wear of the surfaces due to friction caused by excessive positive force. Furthermore, guide surface 140 of main frame 100 guides the smooth insertion of busbar B1 and reduces scratching or jamming during installation.

Finally, the fixing element 50 can help the busbar B1 to be accurately fixed to the busbar clip C1 to avoid installation misalignment or falling off.

The left figure of FIG. 1F is a three-dimensional diagram of a busbar clip according to some embodiments, and the right figure of FIG. 1F is a schematic diagram of the busbar clip C1 shown in the left figure of FIG. 1F after being horizontally flipped 180 degrees.

The busbar clip C1 can be secured to other electronic devices. Specifically, the positioning posts 236 allow the conductive terminal structure 200 to engage with the other electronic device. Screws can also be inserted through the fixing holes 214 to secure the conductive terminal structure 200 to the other electronic components.

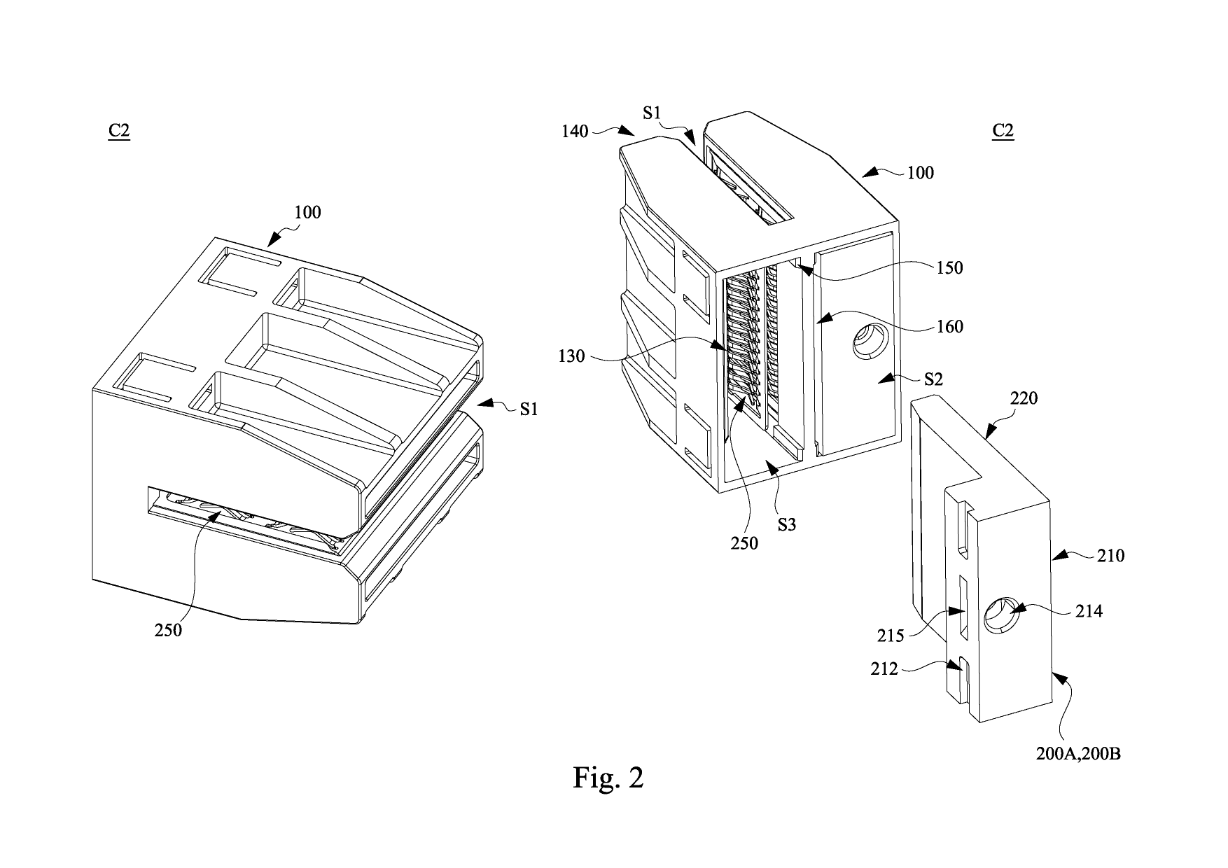

Please refer to FIG. 2. Specifically, the busbar clip C2 of FIG. 2 (the left figure of FIG. 2 is an assembled view of the busbar clip C2, and the right figure is a partially exploded view thereof) is similar to the busbar clip C1 of FIG. 1F. Therefore, similar components will be numbered the same and the relevant details will not be repeated.

The busbar clip C2 has a main frame 100 and a conductive terminal structure 200 similar to those of the aforementioned busbar clip C1, but differs in that the main frame 100 of the busbar clip C2 is a one-piece structure. In other words, the main frame 100 of the busbar clip C2 does not have a separable first frame 100A and second frame 100B, unlike the main frame 100 of the aforementioned busbar clip C1.

In some embodiments, the busbar clip C2 has two separate receiving spaces, receiving space S2 and receiving space S3 adjacent to the receiving space S2, each houses a first conductive terminal structure 200A and a second conductive terminal structure 200B. In some embodiments, receiving spaces S2 and S3 may be separated by a wall 160 of the main frame 100.

First, the conductive terminal structure 200 with the spring structure 250 installed can be combined with the main frame 100. Specifically, the first conductive terminal structure 200A and the second conductive terminal structure 200B of the conductive terminal structure 200 can slide along the guide posts 150 of the main frame 100, respectively, wherein the wall 160 separates the first conductive terminal structure 200A and the second conductive terminal structure 200B so that they do not contact each other.

Then, the fixing groove 212 of the conductive terminal structure 200 can be engaged and fixed with the fixing structure 130 of the main frame 100 to form the busbar clip C2.

The configuration of the busbar clip C2 enables the main frame 100 to be formed into an integral body. This design helps to fix the size of the slot S1 and can be more appropriately used to fix the busbar B1 of a certain thickness.

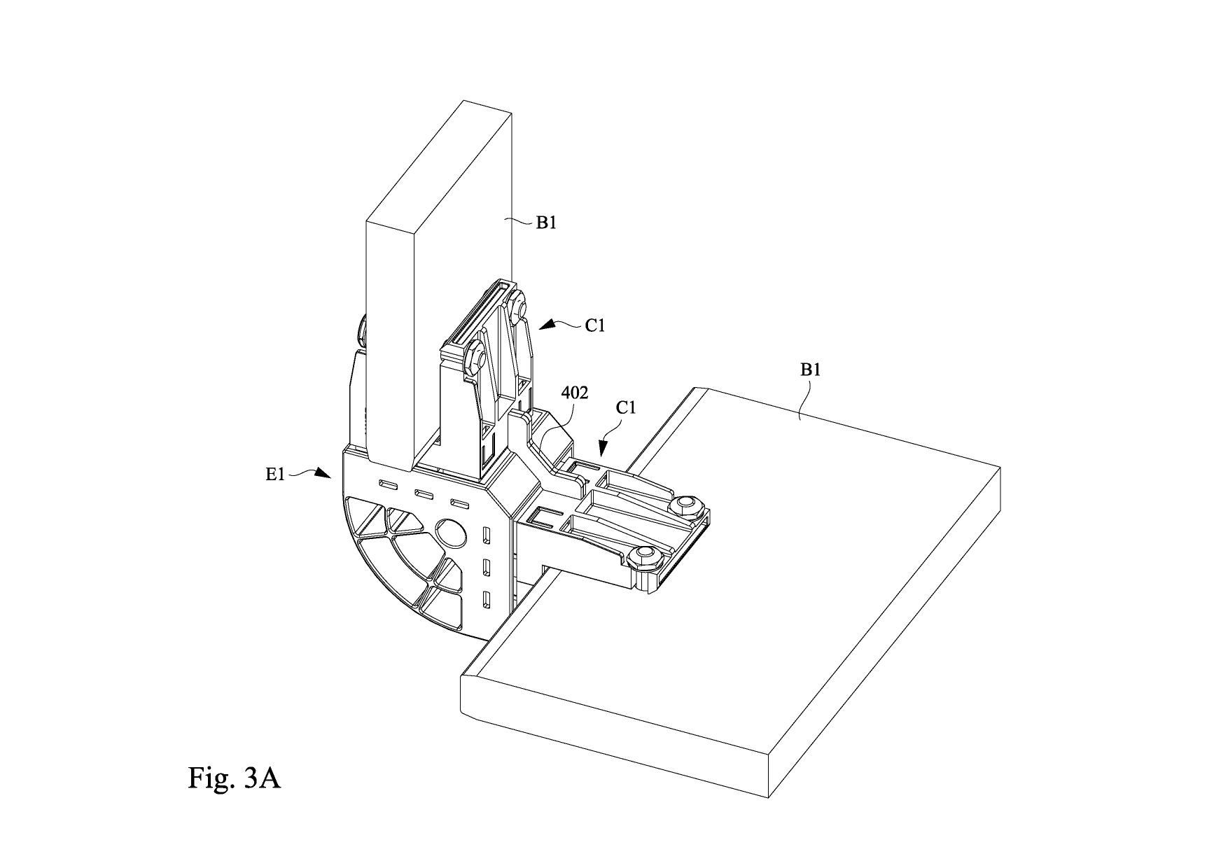

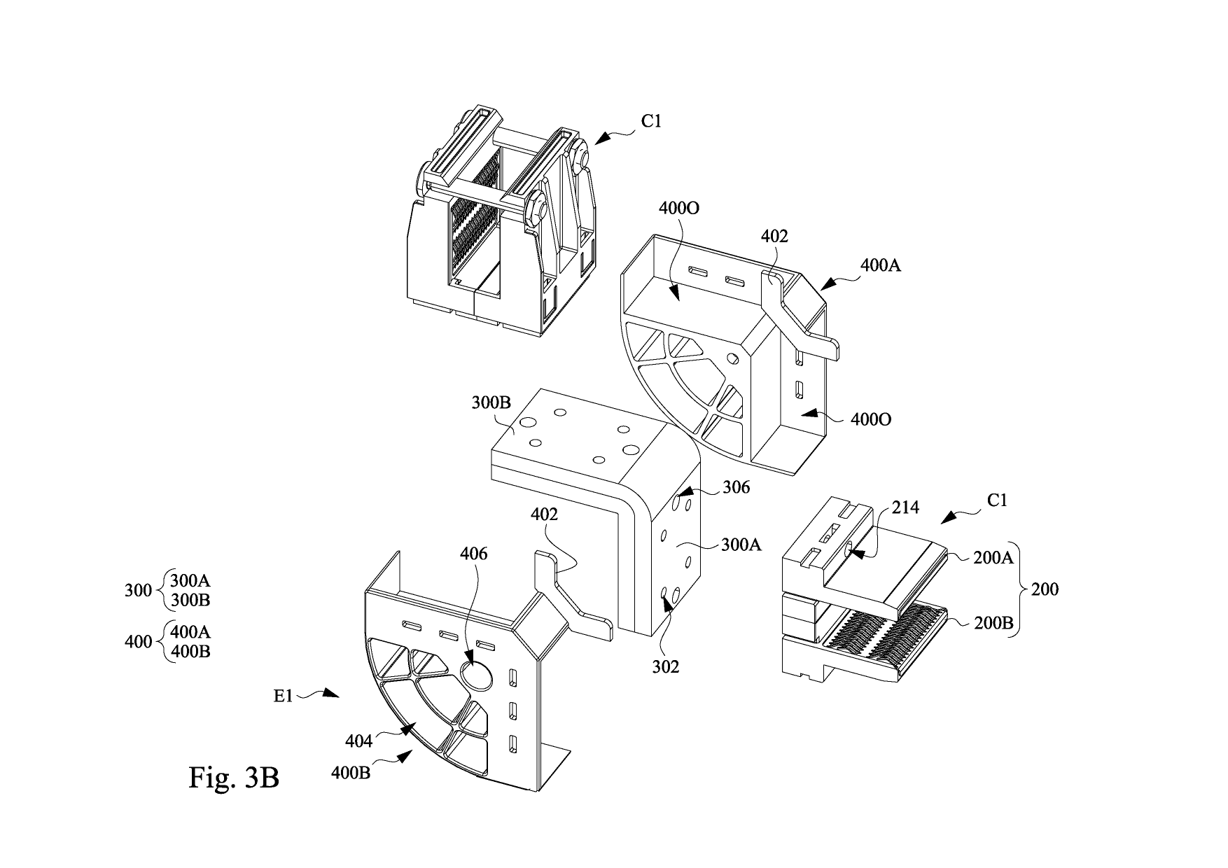

Please refer to FIGS. 3A and 3B. The figures show two busbar clips C1, each used to clip a corresponding busbar B1. Furthermore, the two busbar clips C1 can be electrically connected to each other via a connecting element E1 to form a busbar clip assembly. In this way, current can be transmitted between the two busbars B1 via the busbar clips C1 and the connecting element E1.

In some embodiments, the shape of the connecting element E1 is designed so that the slots of the two busbar clips C1 connected thereto face different directions. For example, in the embodiment of FIG. 3A, the slots of the two busbar clips C1 are arranged at approximately 90 degrees, so the two busbars B1 are also arranged at approximately 90 degrees.

Please refer to FIG. 3B, the connecting element E1 includes a conductive plate 300 and a housing 400 covering the conductive plate 300. In some embodiments, the housing 400 may include a first housing 400A and a second housing 400B. When the first housing 400A and the second housing 400B are assembled, they form a space that can accommodate the conductive plate 300.

The conductive plate 300 has a first connecting portion 300A and a second connecting portion 300B, wherein the first connecting portion 300A and the second connecting portion 300B are connected to each other and are substantially perpendicular to each other. Therefore, the conductive plate 300 has a substantially L-shaped profile. The first connecting portion 300A and the second connecting portion 300B of the conductive plate 300 are configured to respectively connect to corresponding busbar clips C1. More specifically, the first connecting portion 300A and the second connecting portion 300B of the conductive plate 300 can respectively connect to the conductive terminal structure 200 of the busbar clip C1, thereby establishing an electrical connection between the conductive plate 300 and the busbar clip C1.

The first connection portion 300A of the conductive plate 300 may have a plurality of positioning holes 302 and a plurality of fixing holes 306. In some embodiments, the conductive terminal structure 200 of the busbar clip C1 may be fixed to the first connection portion 300A of the conductive plate 300 via the positioning holes 302 and the fixing holes 306. For example, the positioning posts 236 (as shown in FIG. 1D) of the conductive terminal structure 200 may be inserted into the positioning holes 302 to preliminarily fix the conductive terminal structure 200 and the first connection portion 300A of the conductive plate 300. Subsequently, a fixing element (not shown) may be passed through the fixing holes 306 of the first connection portion 300A and the fixing holes 214 of the conductive terminal structure 200 to lock the conductive terminal structure 200 and the first connection portion 300A of the conductive plate 300 together. In some embodiments, the fixing element may include a screw and a nut. Next, after the conductive terminal structure 200 is installed on the first connection portion 300A of the conductive plate 300, the main frame 100 of the busbar clip C1 may be installed to cover the conductive terminal structure 200.

In some embodiments, the first connecting portion 300A may have more positioning holes 302 and fixing holes 306, forming multiple positioning and fixing hole groups. The positioning and fixing hole groups may be designed with different arrangements, allowing the slots of the busbar clip C1 to be fixed to the first connecting portion 300A in different orientations. Specifically, the positioning and fixing hole groups may allow the busbar clip C1 to be fixed to the first connecting portion 300A in at least a first orientation or a second orientation, where the first orientation is substantially perpendicular to the second orientation (i.e., at 90 degrees).

It should be understood that the second connecting portion 300B and the first connecting portion 300A have similar structures, and their connection methods with the busbar clip C1 are also the same, so the relevant details will not be repeated.

As mentioned above, the housing 400 includes a first housing 400A and a second housing 400B. When assembled, the first housing 400A and the second housing 400B together define two connection openings 400O. One connection opening 400O exposes the connection surface of the first connection portion 300A of the conductive plate 300, while the other connection opening 400O exposes the connection surface of the second connection portion 300B of the conductive plate 300.

In some embodiments, the first housing 400A and the second housing 400B of the housing 400 each includes a positioning element 402. As shown in FIG. 3A, after the busbar clip C1 is mounted on the connecting element E1, the positioning element 402 of the housing 400 can abut against the busbar clip C1. This configuration facilitates positioning the busbar clip C1 on the connecting element E1.

In some embodiments, the first housing 400A and the second housing 400B of the housing 400 each have a plurality of heat dissipation holes 404 and fixing holes 406. After the first housing 400A and the second housing 400B are assembled, the fixing holes 406 of the first housing 400A will be connected to the fixing holes 406 of the second housing 400B. A fixing element (not shown) can be passed through the fixing holes 406 of the first housing 400A and the second housing 400B to lock the first housing 400A and the second housing 400B together. In some embodiments, the fixing element includes a screw and a nut.

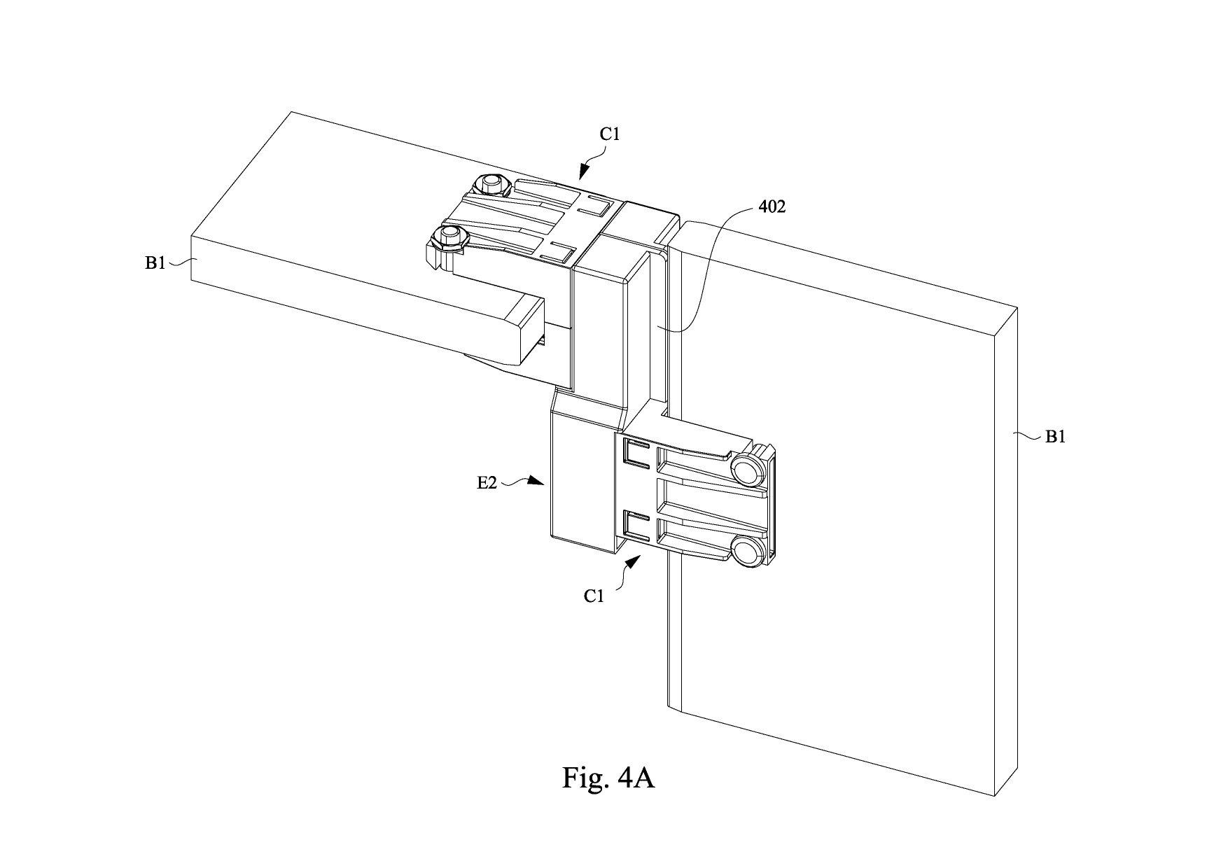

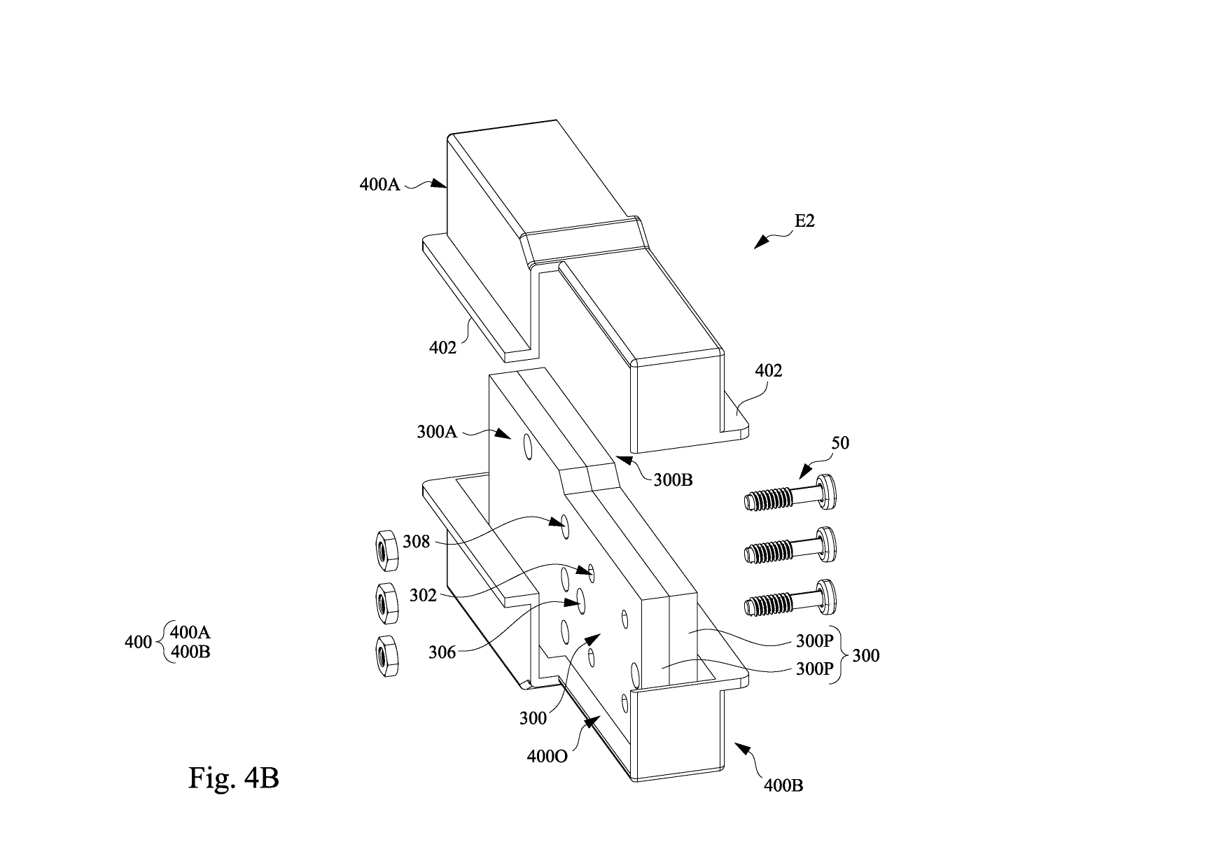

Please refer to FIGS. 4A and 4B. The figure shows two busbar clips C1, each used to clip a corresponding busbar B1. In addition, the two busbar clips C1 can be electrically connected to each other through a connecting element E2 to form a busbar clip assembly. The shape of the connecting element E2 is designed so that the slots of the two busbar clips C1 connected thereto are oriented in different directions. For example, in the embodiment of FIG. 4A, the two busbar clips C1 are located on opposite sides of the connecting element E2, and the slots of the two busbar clips C1 are arranged substantially orthogonally, so the two busbars B1 are also arranged substantially orthogonally.

Referring to FIG. 4B, the connecting element E2 includes a conductive plate 300 and a housing 400 enclosing the conductive plate 300. In some embodiments, the housing 400 may include a first housing 400A and a second housing 400B. When assembled, the first housing 400A and the second housing 400B form a space capable of accommodating the conductive plate 300.

The conductive plate 300 may be formed by stacking a plurality of conductive sheets 300P. Stacking the plurality of conductive sheets 300P increases the thickness of the conductive plate 300 and improves the current carrying capacity (ampacity) of the conductive plate 300.

The conductive plate 300 has a first connecting portion 300A and a second connecting portion 300B, wherein the first connecting portion 300A and the second connecting portion 300B are respectively located at opposite ends and opposite sides of the conductive plate 300. The first connecting portion 300A and the second connecting portion 300B are configured to connect to corresponding busbar clips C1.

The first connecting portion 300A of the conductive plate 300 of the connecting element E2 has substantially the same configuration as the first connecting portion 300A of the conductive plate 300 of the connecting element E1 in FIG. 3B, and therefore, the relevant details will not be repeated. It should be understood that the second connecting portion 300B of the connecting element E2 has a similar structure to the first connecting portion 300A and is connected to the busbar clip C1 in the same manner, and therefore, the relevant details will not be repeated.

In addition, the conductive plate 300 also has a plurality of fixing holes 308, wherein the fixing element 50 can pass through the fixing holes 308, thereby locking the plurality of conductive sheets 300P of the conductive plate 300 together.

Referring to the housing 400, as mentioned above, the housing 400 includes a first housing 400A and a second housing 400B. The first housing 400A and the second housing 400B, when assembled, define two connection openings 400O. One connection opening 400O exposes the connection surface of the first connection portion 300A of the conductive plate 300, while the other connection opening 400O exposes the connection surface of the second connection portion 300B of the conductive plate 300.

In some embodiments, the first housing 400A and the second housing 400B of the housing 400 each includes a positioning element 402. As shown in FIG. 4A, after the busbar clip C1 is mounted on the connecting element E2, the positioning element 402 of the housing 400 can abut against the busbar clip C1. This configuration facilitates positioning the busbar clip C1 on the connecting element E2.

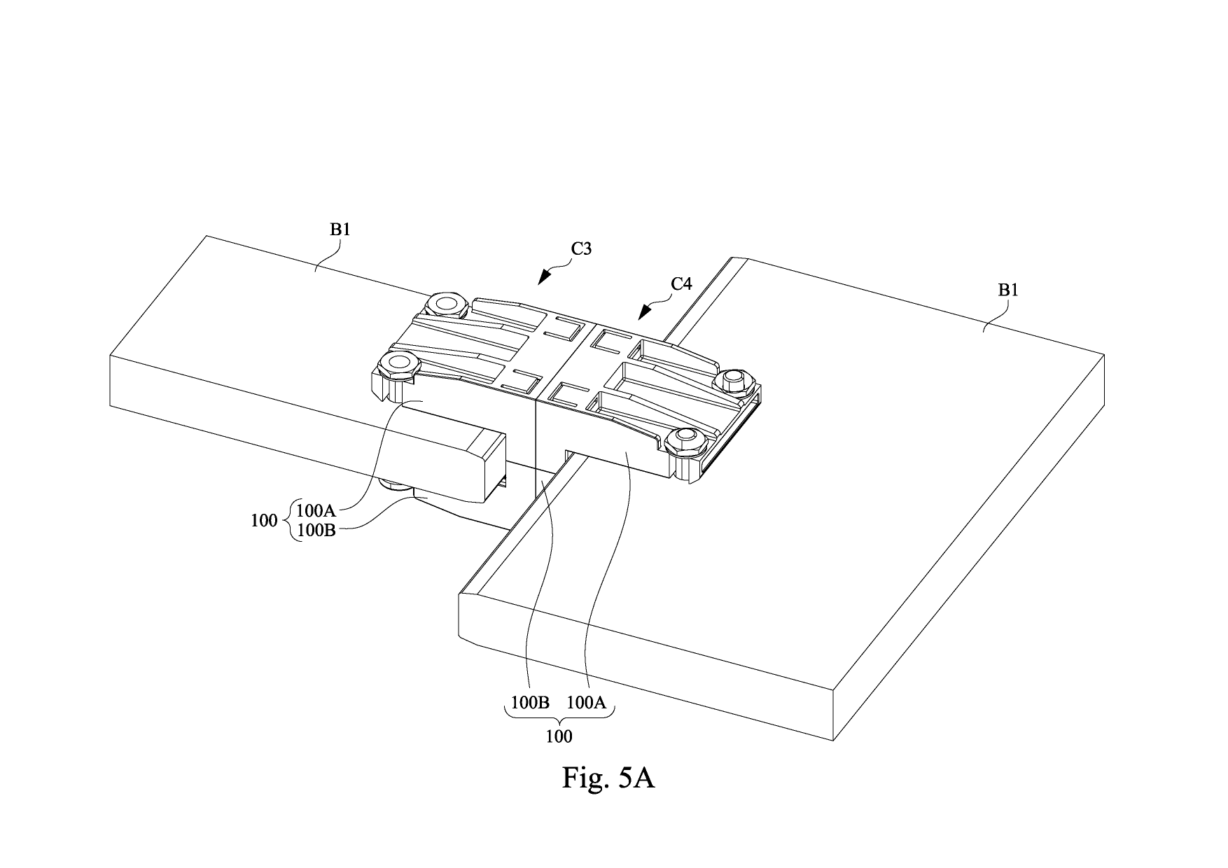

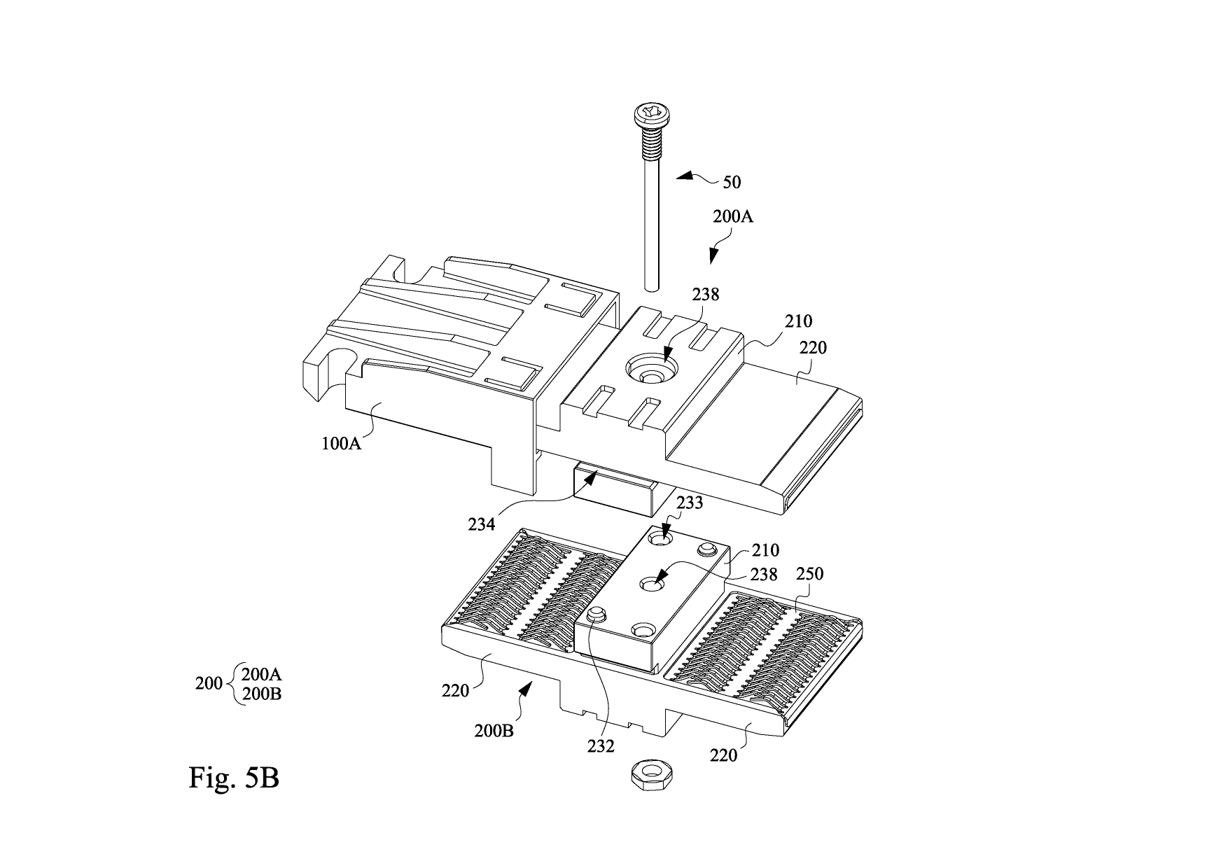

Please refer to FIGS. 5A and 5B. The figures show two busbar clips C3 and C4, each used to clip a corresponding busbar B1. The busbar clips C3 and C4 are electrically connected to form a busbar clip assembly. Current is transmitted between the two busbars B1 through the busbar clips C3 and C4.

Specifically, busbar clips C3 and C4 in FIG. 5A do not have the previously discussed connecting elements E1 or E2 for electrical connection. More specifically, busbar clips C3 and C4 are integrally formed, meaning they share a common conductive terminal structure 200. Referring to FIG. 5B, a conductive terminal structure 200 is shown, wherein the conductive terminal structure 200 is divided into a first conductive terminal structure 200A and a second conductive terminal structure 200B.

The second conductive terminal structure 200B has a base 210 and two conductive platforms 220, which are located on opposite sides of the base 210 and extend in opposite directions. The base 210 has a positioning element 232 and a positioning hole 233, as well as a fixing hole 238. The base 210 also has a guide groove 234, which is configured to allow the conductive terminal structure 200 to engage with the main frame 100. The second conductive terminal structure 200B also includes a plurality of spring structures 250, which are arranged on the corresponding conductive platforms 220. The first conductive terminal structure 200A and the second conductive terminal structure 200B have the same structure, and the relevant details will not be repeated.

First, the first conductive terminal structure 200A and the second conductive terminal structure 200B are assembled together. Specifically, the positioning element 232 of the first conductive terminal structure 200A can be inserted into the corresponding positioning hole 233 of the second conductive terminal structure 200B, and the positioning element 232 of the second conductive terminal structure 200B can be inserted into the corresponding positioning hole 233 of the first conductive terminal structure 200A. This allows the first conductive terminal structure 200A and the second conductive terminal structure 200B to be engaged and fixed to each other, forming a combined, integrated conductive terminal structure 200. Next, the fixing element 50 can be inserted through the fixing holes 238 of the first conductive terminal structure 200A and the second conductive terminal structure 200B to lock the first conductive terminal structure 200A and the second conductive terminal structure 200B together.

Next, the first frame 100A and the second frame 100B of the main frame 100 of the busbar clip C3 can be mounted to the conductive platform 220 and the base 210 corresponding to the first conductive terminal structure 200A and the second conductive terminal structure 200B, respectively. Meanwhile, the first frame 100A and the second frame 100B of the main frame 100 of the busbar clip C4 can be mounted to the conductive platform 220 and the base 210 corresponding to the first conductive terminal structure 200A and the second conductive terminal structure 200B, respectively. The mounting method is similar to that discussed above for the busbar clip C1, and the relevant details will not be repeated here.

As discussed above, busbar clips C3 and C4 can be considered to share a common base 210. In other words, the base 210 of busbar clip C3 and the base 210 of busbar clip C4 are essentially an integrated structure. This design helps to reduce the volume of the overall structure.

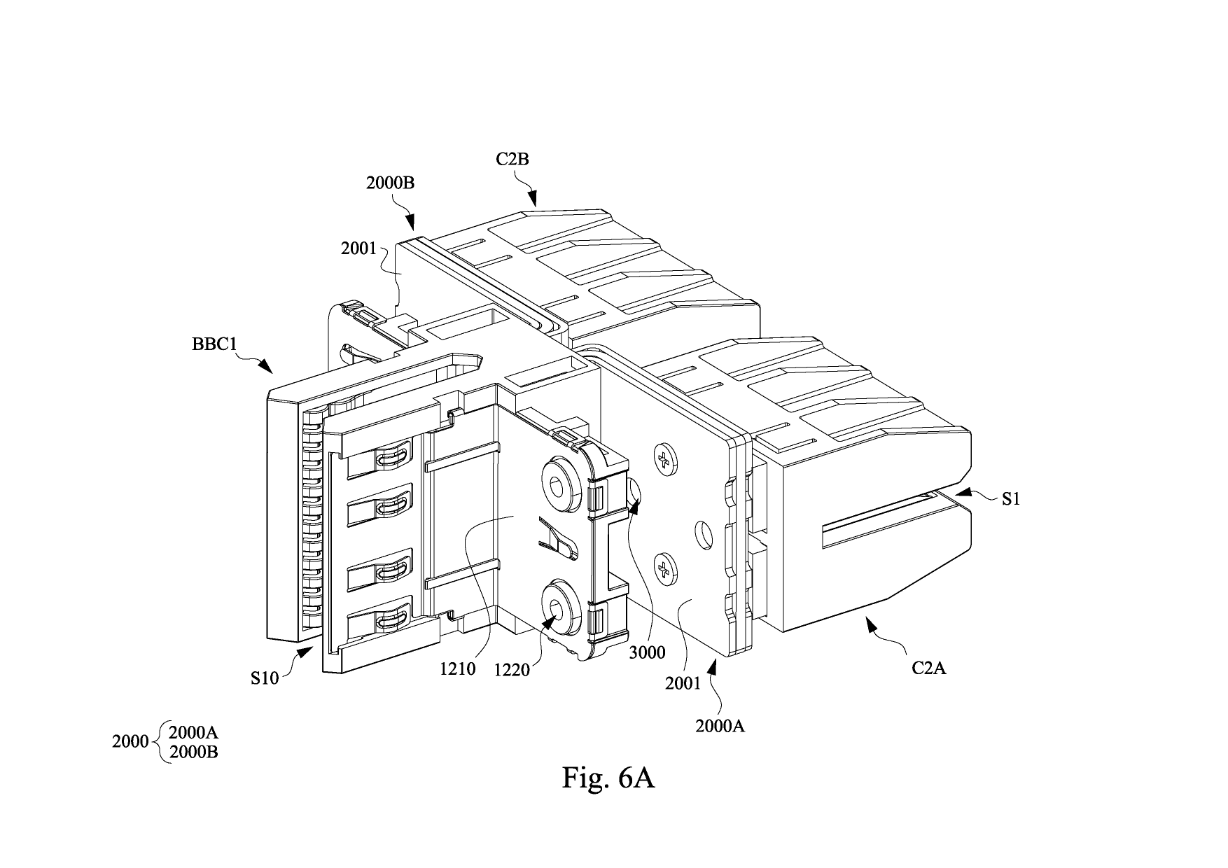

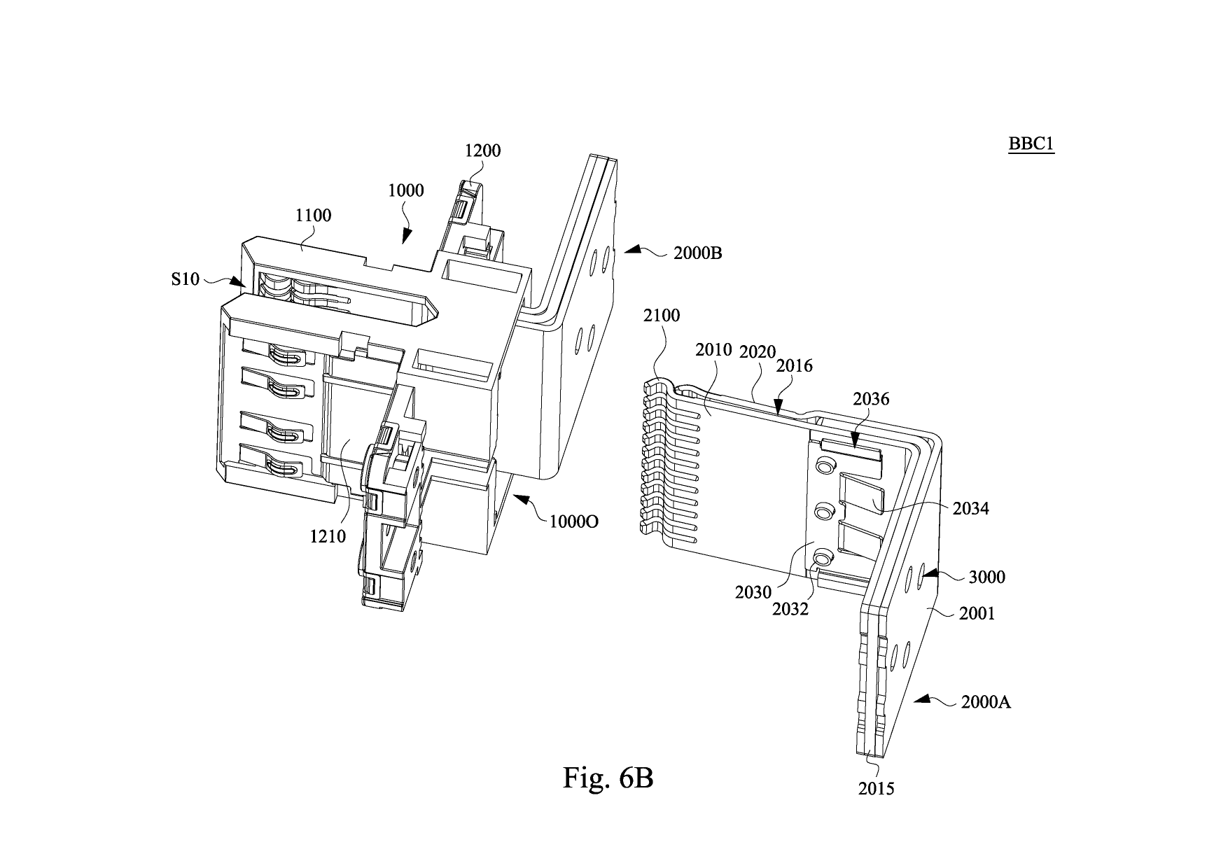

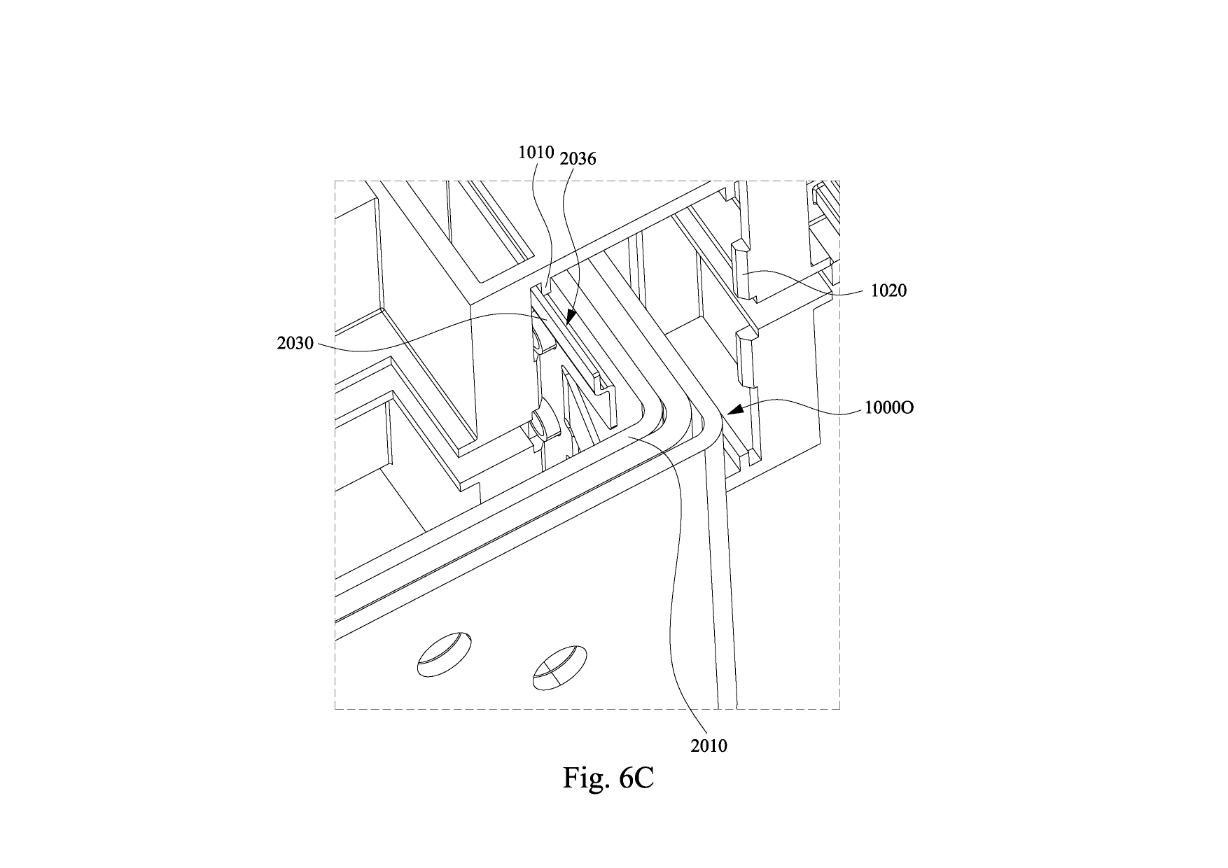

Please refer to FIGS. 6A, 6B, and 6C. In some embodiments, the connecting element can be a connector (e.g., a busbar clip connector). The figure shows two busbar clips C2A and C2B, each electrically connected to the connector BBC1. This configuration allows the connector BBC1 to transmit current to the two busbars B1. The two busbar clips C2A and C2B in FIG. 6A are substantially the same as the busbar clip C2 in FIG. 2, and therefore the relevant details are not repeated. In other embodiments, the busbar clips C2A and C2B can also be the same as the busbar clip C1 in FIG. 1A.

Specifically, the connector BBC1 has a slot S10 that can be inserted into and electrically connected to a bus system (e.g., a rack bus system, not shown in the figure). The connector BBC1 also has a first conductive strip 2000A and a second conductive strip 2000B adjacent to the first conductive strip 2000A. One end of the first conductive strip 2000A and the second conductive strip 2000B of the connector BBC1 can be connected to the bus system. For example, the bus system can have two docking terminals that are inserted into the slot S10 of the connector BBC1 and electrically connected to the corresponding conductive terminals, the first conductive strip 2000A and the second conductive strip 2000B. The two docking terminals of the bus system can provide the same or different potentials, respectively. For example, a first voltage (positive voltage or ground voltage) and a second voltage (positive voltage or ground voltage). On the other hand, the other ends of the first conductive strip 2000A and the second conductive strip 2000B can be electrically connected to the busbar clips C2A and C2B, respectively. This configuration can transmit the current of the bus system to other electronic components through the busbar clips C2A and C2B.

More specifically, the first conductive strip 2000A has a connecting portion 2001, wherein the first conductive terminal structure 200A of the busbar clip C2A can be fixed to the connecting portion 2001. Similarly, the second conductive strip 2000B has a connecting portion 2001, wherein the second conductive terminal structure 200B of the busbar clip C2B can be fixed to the connecting portion 2001.

In some embodiments, the connection portion 2001 of the first conductive strip 2000A may have a plurality of fixing holes 3000, forming multiple fixing hole groups. The fixing hole groups may be designed with different arrangements, allowing the fixing holes of the busbar clip C2A (such as the fixing holes 214 shown in FIG. 2) to be fixed to the first conductive strip 2000A in different orientations. For example, in the embodiment of FIG. 6A, the busbar clip C2A is fixed to the first conductive strip 2000A via one set of fixing holes 3000, such that the slot S10 of the connector BBC1 and the slot S1 of the busbar clip C2A are perpendicular and substantially orthogonal. In other embodiments, the busbar clip C2A may be rotated (e.g., 90 degrees) and fixed to the first conductive strip 2000A via another set of fixing holes 3000, such that the slot S10 of the connector BBC1 and the slot S1 of the busbar clip C2A are parallel. In other words, the fixing hole 3000 is designed so that the busbar clip C2A can be fixed to the connecting portion 2001 of the first conductive strip 2000A in a first direction or a second direction, wherein the first direction is substantially perpendicular to the second direction (ie, at 90 degrees).

Busbar clip C2B and second conductive strip 2000B of connector BBC1 have the same connection method, and the relevant details will not be repeated. As mentioned above, busbar clip C2A can be fixed to first conductive strip 2000A in two directions. Similarly, busbar clip C2B can be fixed to second conductive strip 2000B in two directions. Therefore, busbar clips C2A and C2B can be arranged in 2x2 combinations on connector BBC1. This design helps provide greater electrical connection flexibility.

Connector BBC1 includes a housing 1000 and conductive strips 2000A and 2000B mounted within the housing 1000. The housing 1000 has two extensions 1100 forming a slot S10. On opposite sides of the slot S10, the housing 1000 has two receiving spaces 1000O, each corresponding to the extensions 1100. The conductive strips 2000A and 2000B are inserted into the housing 1000 through the receiving spaces 1000O.

The housing 1000 also has wings 1200 that extend toward the side of the housing 1000 and are located between the extension 1100 and the receiving space 1000O. In some embodiments, each wing 1200 has at least one hole 1220 (as shown in FIG. 6A). The housing 1000 can be fixed to an external housing, such as a server housing, via the wings 1200. For example, the surface of the wing 1200 facing the slot S10 can be placed against an external housing, and the holes 1220 of the wing 1200 can be aligned with the holes on the external housing. Then, a fixing element, such as a screw or a rivet, is passed through the holes 1220 of the wing 1200 and the holes on the external housing to lock the wing 1200 of the housing 1000 to the external housing.

In some embodiments, the connector BBC1 further includes a grounding plate 1210 mounted on the wing 1200 and the extension 1100 corresponding to the wing 1200. In some embodiments, the grounding plate 1210 has an L-shaped structure. In some embodiments, the grounding plate 1210 is made of metal.

Each of the conductive strips 2000A and 2000B includes an outer conductive strip 2010 and an inner conductive strip 2020 adjacent to the outer conductive strip 2010, wherein the outer conductive strip 2010 and the inner conductive strip 2020 are separated from each other. Each of the outer conductive strip 2010 and the inner conductive strip 2020 includes a plurality of conductive contact terminals 2100. Specifically, when the conductive strips 2000A and 2000B are inserted into the housing 1000, the conductive contact terminals 2100 can be exposed in the slots S10 and can be electrically connected to the mating terminals.

Each of the conductive strips 2000A and 2000B further includes an intermediate conductive strip 2015 located between the outer conductive strip 2010 and the inner conductive strip 2020. Specifically, the intermediate conductive strip 2015 is located between the ends of the outer conductive strip 2010 and the inner conductive strip 2020, and together with the outer conductive strip 2010 and the inner conductive strip 2020, forms a connection portion 2001. On the other hand, there is no intermediate conductive strip 2015 between the front ends of the outer conductive strip 2010 and the front ends of the inner conductive strip 2020, but an air gap 2016 is provided.

Each of the conductive strips 2000A and 2000B further includes a positioning piece 2030 located on the outer surface of the outer conductive strip 2010. The positioning piece 2030, the outer conductive strip 2010, the intermediate conductive strip 2015, and the inner conductive strip 2020 may each have a fixing hole and may be fixed using one or more fixing elements 2032. In some embodiments, the positioning piece 2030 includes a protruding spring piece 2034 extending outward from the surface of the positioning piece 2030 toward the busbar clip C2A or C2B. The protruding spring piece 2034 is configured to engage with the housing 1000 when the conductive strips 2000A and 2000B are inserted into the housing 1000.

Each of the conductive strips 2000A and 2000B also has a guide groove 2036 formed by the outer conductive strip 2010 and the positioning piece 2030.

Please refer to FIG. 6C, which shows a schematic diagram of conductive strip 2000A being inserted into housing 1000's receiving space 1000O. The inner sidewall of housing 1000 may have a plurality of guide posts 1010. When conductive strip 2000A is inserted into housing 1000, guide posts 1010 may be inserted into guide grooves 2036 between the outer conductive strip 2010 and positioning piece 2030 of conductive strip 2000A, thereby guiding conductive strip 2000A into housing 1000. Furthermore, a plurality of stoppers 1020 are provided on the inner surface of housing 1000. When the conductive strip 2000A is inserted into the housing 1000, the spring piece 2034 of the positioning piece 2030 enters along the stopper 1020, and the stopper 1020 presses the spring piece 2034 toward the outer conductive strip 2010 until the spring piece 2034 passes the stopper 1020. The spring piece 2034 then rebounds and abuts against the stopper 1020, preventing the conductive strip 2000A from falling out of the housing 1000. It should be understood that the conductive strip 2000B is inserted into the housing 1000 in the same manner as the conductive strip 2000A, and therefore the relevant details will not be repeated here.

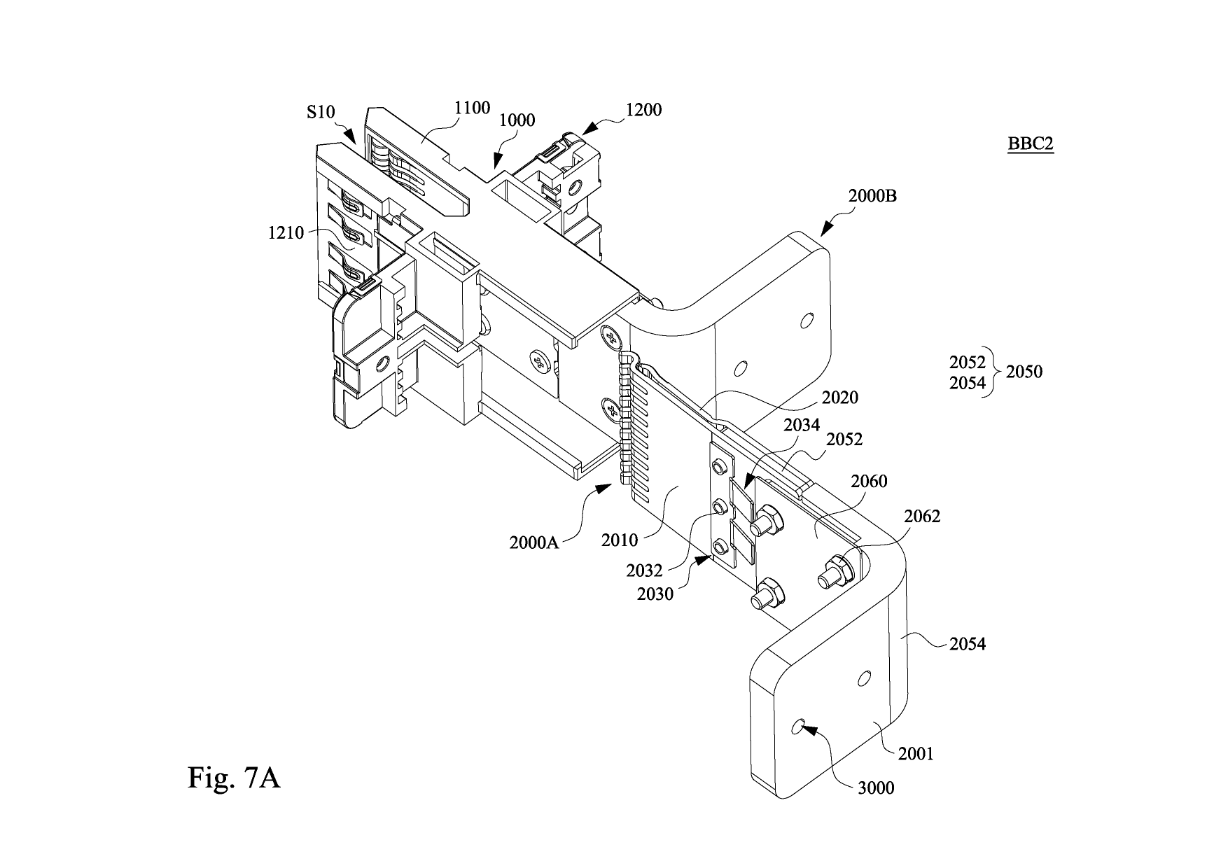

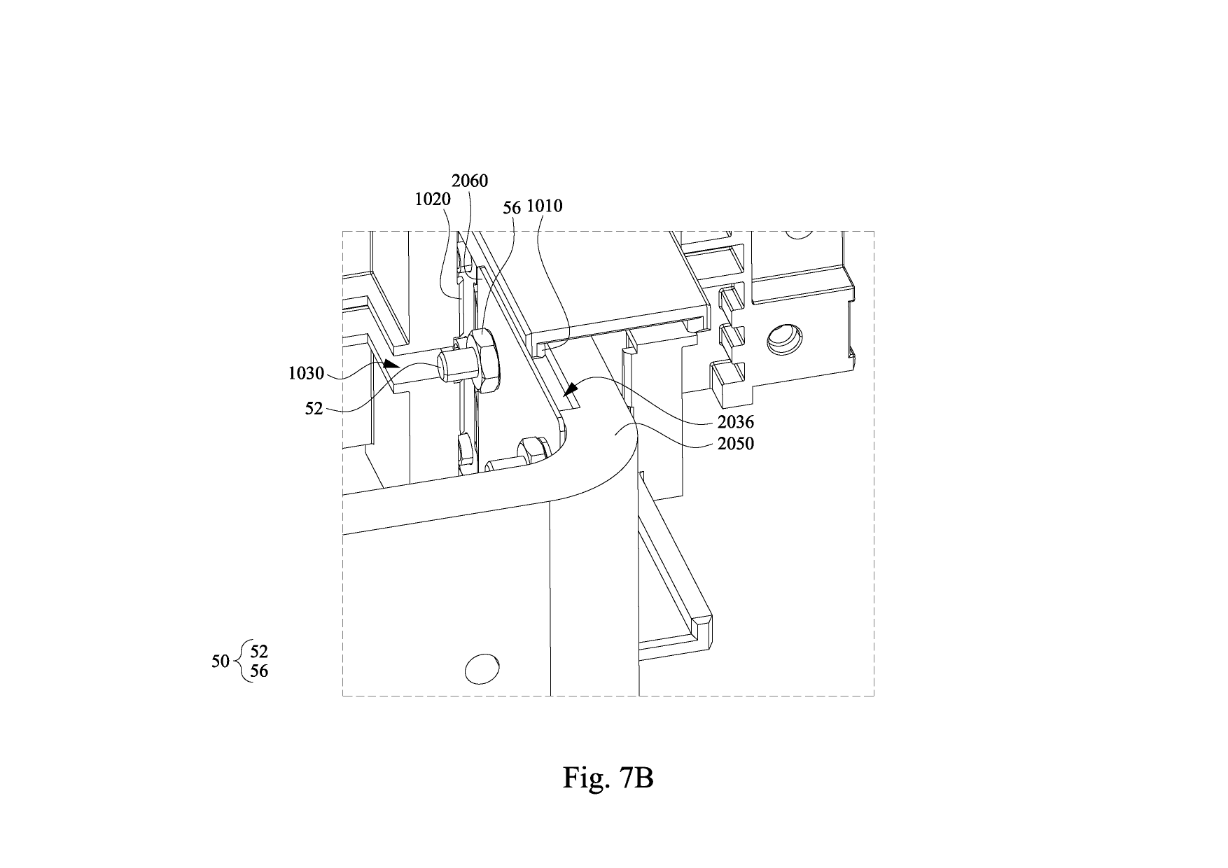

Connector BBC2 of FIG. 7A is similar to connector BBC1 of FIG. 6A. Therefore, similar components are numbered the same and related details are not repeated. Specifically, connector BBC2 differs from connector BBC1 of FIG. 6A in that conductive strips 2000A and 2000B each have an extension piece 2050 and a connection piece 2060 covering extension piece 2050.

The extension piece 2050 includes a first portion 2052 and a second portion 2054 connected to the first portion 2052. In some embodiments, the first portion 2052 is located between the outer conductive strip 2010 and the inner conductive strip 2020. Specifically, the first portion 2052 is located between the end of the outer conductive strip 2010 and the end of the inner conductive strip 2020.

On the other hand, the second portion 2054 connects the first portion 2052, the outer conductive strip 2010, and the ends of the inner conductive strip 2020. The second portion 2054 may form the connecting portion 2001 and include a plurality of fixing holes 3000. Details regarding the connecting portion 2001 and the fixing holes 3000 are shown in FIG. 6A. In some embodiments, the thickness of the second portion 2054 is greater than the thickness of the first portion 2052. In some embodiments, the second portion 2054 has a curved profile that can change the orientation of the connecting portion 2001 and the orientation of a clip attached to the connecting portion 2001. Specifically, the second portion 2054 has an L-shaped profile.

Connector BBC2 further includes a connecting piece 2060 that covers the second portion 2054 of the extension piece 2050 and a portion of the outer conductive strip 2010. The connecting piece 2060 has a plurality of fixing holes 2062. Some of the fixing holes 2062 are configured to allow fixing elements to pass through and secure the connecting piece 2060, the outer conductive strip 2010, the first portion 2052 of the extension piece 2050, and the inner conductive strip 2020. Other fixing holes 2062 are configured to allow fixing elements to pass through and secure the connecting piece 2060 and the second portion 2054 of the extension piece 2050.

Each of the conductive strips 2000A and 2000B also has a guide groove 2036 formed by the outer conductive strip 2010 (or the extension piece 2050) and the connecting piece 2060.

Please refer to FIG. 7B, which is a schematic diagram of the conductive strip 2000A of the connector BBC2 being inserted into the receiving space 1000O of the housing 1000.

First, the fixing element 50 can be inserted into the fixing hole 2062 to secure the connecting piece 2060, the outer conductive strip 2010, the first portion 2052 of the extension piece 2050, and the inner conductive strip 2020, thereby locking the connecting piece 2060 and the second portion 2054 of the extension piece 2050. The fixing element 50 can include a screw 52 and a nut 56 that passes through the screw 52.

Next, conductive strips 2000A and 2000B are inserted into housing 1000. The following description will focus on conductive strip 2000A. The inner wall of housing 1000 may have a plurality of guide posts 1010. When conductive strip 2000A is inserted into housing 1000, guide posts 1010 may be embedded in guide grooves 2036 between extension piece 2050 and connection piece 2060 of conductive strip 2000A, thereby guiding conductive strip 2000A into housing 1000.

Furthermore, a plurality of stoppers 1020 are provided on the inner surface of the housing 1000. When the conductive strip 2000A is inserted into the housing 1000, the spring pieces 2034 of the positioning piece 2030 enter along the stoppers 1020. The stoppers 1020 press the spring pieces 2034 toward the outer conductive strip 2010 until the spring pieces 2034 pass through the stoppers 1020. The spring pieces 2034 then rebound and abut against the stoppers 1020, preventing the conductive strip 2000A from falling out of the housing 1000.

On the other hand, the housing 1000 also has a guide groove 1030. When the conductive strip 2000A is inserted into the housing 1000, the screw 52 can enter along the guide groove 1030 to fix the conductive strip 2000A.

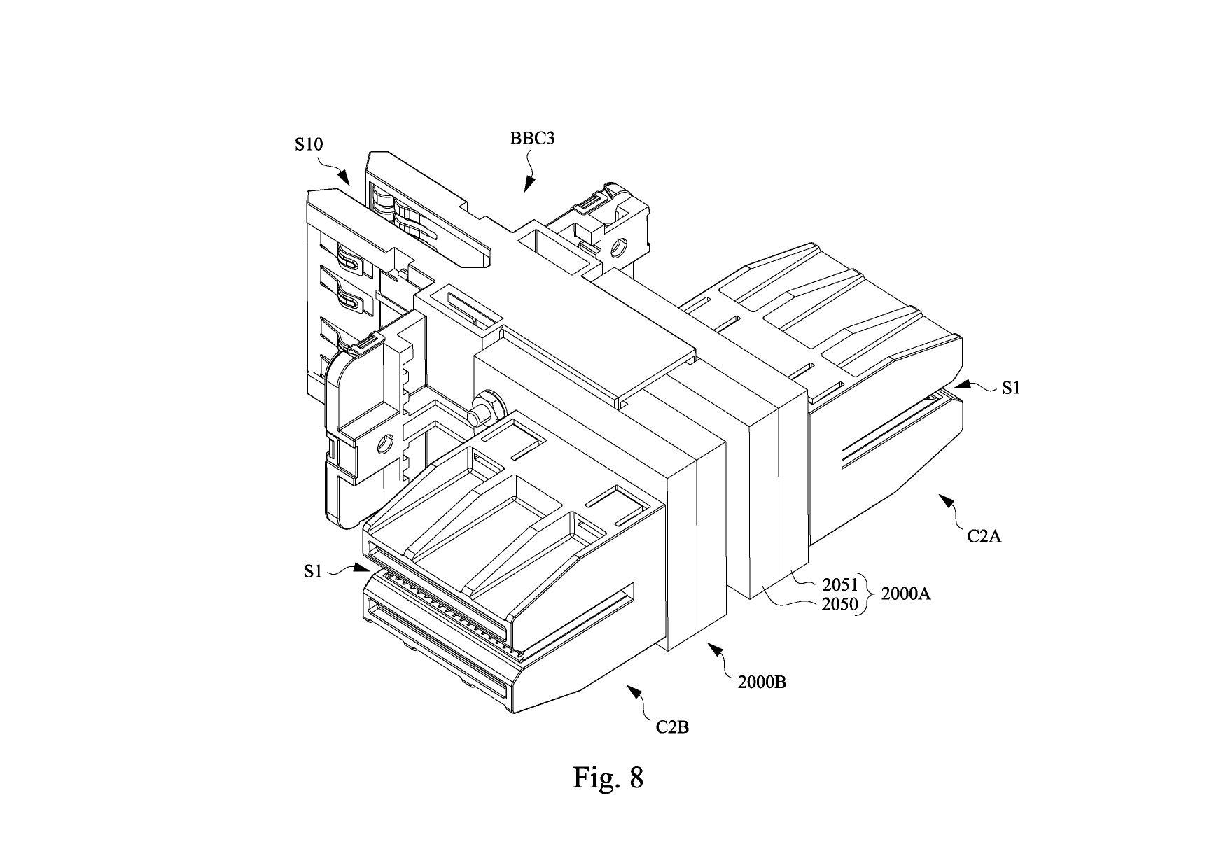

FIG. 8 is a perspective view of a connector assembly according to some embodiments. The connector BBC3 in FIG. 8 is similar to the connector BBC2 in FIG. 7A, and thus similar components will be numbered the same and related details will not be repeated.

Specifically, compared to connector BBC2 in FIG. 7A, the extension pieces 2050 of each of conductive strips 2000A and 2000B in connector BBC3 in FIG. 8 do not have a curved profile. Furthermore, conductive strips 2000A and 2000B in connector BBC3 in FIG. 8 each further include an extension piece 2051, wherein extension piece 2051 contacts extension piece 2050. Busbar clips C2A and C2B are respectively fixed above extension piece 2051. Specifically, extension pieces 2050 and 2051 have a plurality of fixing holes 3000, and busbar clips C2A and C2B can be fixed to extension pieces 2050 and 2051, respectively, through fixing elements via fixing holes 3000. As previously mentioned, each pair of extension piece 2050 and 2051 can have multiple sets of fixing holes 3000, allowing busbar clips C2A and C2B to be fixed to conductive strips 2000A and 2000B in different orientations. Busbar clips C2A and C2B in FIG. 8 are substantially identical to busbar clip C2 in FIG. 2, and therefore, the relevant details are not further described. In other embodiments, busbar clips C2A and C2B can also be identical to busbar clip C1 in FIG. 1A.

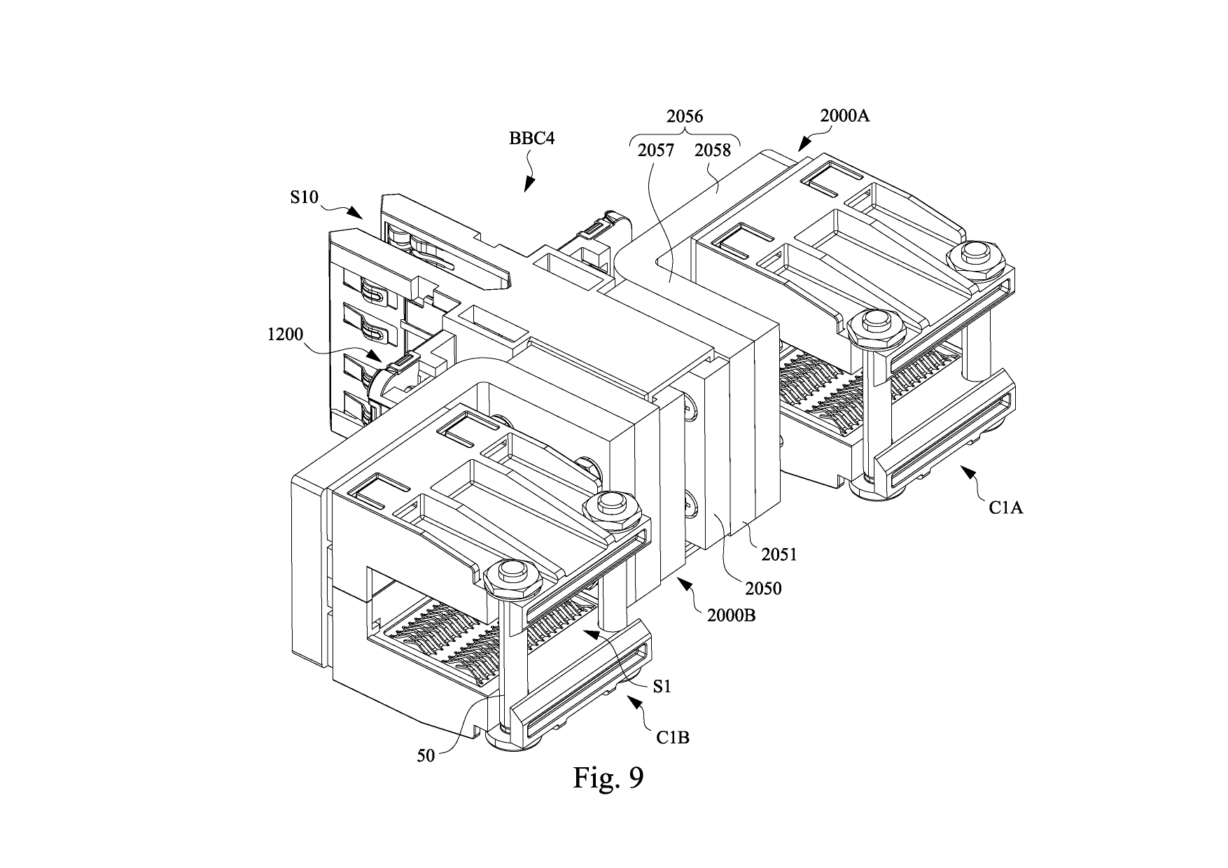

The connector BBC4 of FIG. 9 is similar to the connector BBC3 of FIG. 8. Therefore, similar components will be numbered the same, and related details will not be repeated. Specifically, the connector BBC4 of FIG. 9 differs from the connector BBC3 of FIG. 8 in that the conductive strips 2000A and 2000B are each further provided with an extension piece 2056. The extension piece 2056 contacts the extension piece 2051 and has a curved profile. For example, the extension piece 2056 has an L-shaped profile. In some embodiments, the extension piece 2056 has a first portion 2057 and a second portion 2058. The first portion 2057 contacts the extension piece 2051, and the second portion 2058 is perpendicular to the first portion 2057 and is located at an end of the first portion 2057 that is closer to the wing 1200 of the housing 1000.

Busbar clips C1A and C1B are each secured to the second portion 2058 of the extension piece 2056. Specifically, the second portion 2058 of the extension piece 2056 has a plurality of securing holes 3000, and the busbar clips C1A and C1B can be secured to the second portion 2058 of the extension piece 2056 via securing elements (e.g., screws) through the securing holes 3000. Similar to the aforementioned, the second portion 2058 of the extension piece 2056 can have multiple sets of securing holes 3000, allowing the busbar clips C1A and C1B to be secured to the conductive strips 2000A and 2000B in different orientations. The busbar clips C1A and C1B of FIG. 9 are substantially identical to the busbar clip C1 of FIG. 1A, and thus, the relevant details are not further described. In other embodiments, the busbar clips C1A and C1B can also be identical to the busbar clip C2 of FIG. 2.

In some embodiments, the curved profile formed by the extension piece 2056 can be adjacent to both sides of the busbar clips C1A and C1B. For example, the first portion 2057 of the extension piece 2056 is adjacent to one side of the busbar clip C1A, while the second portion 2058 is adjacent to the other side of the busbar clip C1A. Therefore, the connector BBC4 and the busbar clips C1A and C2A can have a smaller volume after assembly. The connector BBC4 can lock the busbars in the slots S1 of the busbar clips C1A and C1B respectively by means of the fixing element 50. As mentioned above, the fixing element 50 is configured to enhance the normal force between the busbar clips C1A and C2A and the busbars. Therefore, the thickness of the busbars locked in the busbar clips C1A and C1B can be less restricted and can transmit a larger current.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A busbar clip assembly, comprising:
a plurality of busbar clips, each configured to clip a plurality of busbars respectively, wherein,
each busbar clip comprises a main frame and a conductive terminal structure installed in the main frame, and wherein,
the conductive terminal structure of one busbar clip is directly connected to the conductive terminal structure of the other busbar clip or connected through a connecting element.

2. The busbar clip assembly of claim 1, wherein a spring structure is disposed on the conductive terminal structure, and the spring structure contacts one of the busbars.

3. The busbar clip assembly of claim 1, wherein:
the conductive terminal structure of one of the busbar clips comprises a first conductive terminal and a second conductive terminal, and the conductive terminal structure of the other of the busbar clips comprises a first conductive terminal and a second conductive terminal, wherein the first conductive terminal of the conductive terminal structure of the one of the busbar clips and the first conductive terminal of the conductive terminal structure of the other of the busbar clips are integrally formed, and the second conductive terminal of the conductive terminal structure of the one of the busbar clips and the second conductive terminal of the conductive terminal structure of the other of the busbar clips are integrally formed.

4. The busbar clip assembly of claim 1, wherein the connecting element comprises a housing and a conductive plate disposed in the housing, wherein the busbar clips are fixed on the conductive plate.

5. The busbar clip assembly of claim 1, wherein the connecting element comprises a conductive plate with an L-shaped profile, and the busbar clips are fixed on the conductive plate.

6. The busbar clip assembly of claim 1, wherein the connecting element comprises a conductive plate with a plurality of conductive sheets, and the busbar clips are fixed on the conductive plate.

7. The busbar clip assembly of claim 1, wherein each of the busbar clips can be fixed on the connecting element in two different directions.

8. A connector assembly, comprises:
a busbar clip assembly comprising:
a plurality of busbar clips, each configured to clip a plurality of busbars, wherein each of the busbar clips comprises a main frame and a conductive terminal structure mounted within the main frame; and
a connector, electrically connected to the conductive terminal structure of one of the busbar clips and the conductive terminal structure of another of the busbar clips, and comprising:
a housing;
a plurality of conductive strips, comprising:
a first conductive strip disposed within the housing and configured to receive a first voltage, wherein one of the busbar clips is electrically connected to the first conductive strip; and
a second conductive strip disposed within the housing and configured to receive a second voltage, wherein the other of the busbar clips is electrically connected to the second conductive strip, and wherein the second voltage is the same as or different from the first voltage.

9. The connector assembly of claim 8, wherein one of the conductive strips comprises:
an outer conductive strip;
an inner conductive strip adjacent to but not in contact with the outer conductive strip; and
an intermediate conductive strip between the outer conductive strip and the inner conductive strip.

10. The connector assembly of claim 9, wherein the conductive strips further comprises:
a positioning piece on an outer surface of the outer conductive strip, wherein when the conductive strips are installed in the housing of the connector, the positioning piece abuts against a stopper of the housing.

11. The connector assembly of claim 10, wherein a guide groove is defined between the outer conductive strip and the positioning piece, wherein when the one of the conductive strips is installed in the housing, a guide post of the housing is embedded in the guide groove.

12. The connector assembly of claim 8, wherein one of the conductive strips comprises:
an outer conductive strip;
an inner conductive strip adjacent to but not contacting the outer conductive strip; and
an extension strip, comprising:
a first portion positioned between the outer conductive strip and the inner conductive strip; and
a second portion connected to the first portion, wherein the second portion has a thickness greater than that of the first portion, and wherein one of the busbar clips is mounted on the second portion.

13. The connector assembly of claim 12, wherein the second portion has a curved profile.

14. The connector assembly of claim 8, wherein one of the conductive strips comprises:
a first extension piece contacting the one of the conductive strips;
a second extension piece contacting the first extension piece; and
a third extension piece, comprising:
a first portion contacting the second extension piece; and
a second portion connected to an end of the first portion proximal to a slot of the connector and aligned approximately 90 degrees to the first portion, wherein one of the busbar clips is mounted on the second portion.

15. A busbar clip, comprises:
a plurality of conductive terminal structures, comprising:
a base;
a conductive platform extending from the base;
a spring structure disposed on the conductive platform; and
a main frame enclosing the conductive terminal structures, wherein the main frame comprises a separable first frame and a separable second frame.

16. The busbar clip of claim 15, wherein the base of one of the conductive terminal structures has a positioning column, and the base of the other one has a positioning hole, and the positioning column is inserted into the positioning hole.

17. The busbar clip of claim 15, wherein the base of the conductive terminal structures comprises a guide groove coupled with a guide column of the main frame.

18. A busbar clip, comprises:
a plurality of conductive terminal structures, comprising:
a base;
a conductive platform extending from the base;
a spring structure disposed on the conductive platform; and
a main frame enclosing the conductive terminal structures, wherein the main frame is a one-piece structure, and the conductive terminal structures are separated by a wall of the main frame.

19. A busbar clip, comprises:
a plurality of conductive terminal structures, comprising:
a base;
a first conductive platform extending from the base in a first direction;
a second conductive platform extending from the base in a second direction opposite to the first direction; and
a plurality of spring structures disposed on the first conductive platform and the second conductive platform;
a first main frame enclosing the first conductive platform of each of the conductive terminal structures; and
a second main frame enclosing the second conductive platform of each of the conductive terminal structures.

20. The busbar clip of claim 19, wherein each of the first main frame and the second main frame comprises a separable first frame and a separable second frame.
